(19) United States
(12) Patent Application Publication
(10) Pub. No.: US 2026/0199069 A1
(43) Pub. Date: Jul. 16, 2026

(54) ELECTRIC TOOTHBRUSH AND CONTROL METHOD THEREOF

(71) Applicant: GUANGZHOU STARS PULSE CO.,LTD., GUANGZHOU (CN)

(72) Inventors: JILI YANG, GUANGZHOU (CN); HAOZHE TIAN, GUANGZHOU (CN); YU ZOU, GUANGZHOU (CN)

(21) Appl. No.: 19/558,768

(22) Filed: Mar. 6, 2026

Related U.S. Application Data
(63) Continuation of application No. PCT/CN2024/107731, filed on Jul. 26, 2024.

(30) Foreign Application Priority Data
Dec. 29, 2023 (CN) 202311872118.9
Dec. 29, 2023 (CN) 202323664441.5

(51) Int. Cl. A61C 17/22; A46B 13/02; A46B 15/00; A61C 17/34

(52) U.S. Cl. CPC A61C 17/221; A46B 13/023; A46B 15/0006; A61C 17/225; A61C 17/3472; A61C 17/3481; A61C 17/3445; A61C 17/3454

(57) ABSTRACT

An electric toothbrush and a control method thereof are provided. The electric toothbrush includes a handle, a circuit board, a bidirectional motor connected to the circuit board, and a brush head. The circuit board and the bidirectional motor are disposed in the handle. The bidirectional motor is connected to the brush head. The control method includes obtaining an oral cleaning instruction; determining a first driving signal and a second driving signal corresponding to the oral cleaning instruction in response to the oral cleaning instruction, controlling a cleaning component (i.e., the brush head) to generate a first motion and a second motion having different motion direction based on the first driving signal and the second driving signal, and simultaneously outputting the first driving signal and the second driving signal to enable the cleaning component to performs a combined motion of the first motion and the second motion.

### CROSS-REFERENCE TO RELATED APPLICATION

The present disclosure claims foreign priority to Chinese Patent Application No. CN202311872118.9 titled: “CONTROL METHOD OF ELECTRIC TOOTHBRUSH, CONTROL DEVICE OF ELECTRIC TOOTHBRUSH, ELECTRIC TOOTHBRUSH, AND STORAGE MEDIUM”, filed on Dec. 29, 2023 in the State Intellectual Property Office of China, and the entire contents of which is hereby incorporated by reference. The present disclosure further claims foreign priority to Chinese Patent Application No. CN202323664441.5, titled: “ELECTRIC TOOTHBRUSH”, filed on Dec. 29, 2023 in the State Intellectual Property Office of China, and the entire contents of which is hereby incorporated by reference.

### TECHNICAL FIELD

The present disclosure relates to a technical field of oral cleaning, and in particular to a control method of an electric toothbrush and the electric toothbrush.

### BACKGROUND

An electric toothbrush is configured to clean teeth by driving a brush head thereof to scrape surfaces of teeth through a motor thereof. In related art, the brush head is driven by the motor to generate high-frequency vibration or rotation. However, the vibration or rotation of electric toothbrush has limited cleaning ability on the teeth, and a user need to laterally move the brush head or longitudinally brushing the teeth to achieve a desired cleaning effect. Therefore, how to improve the cleaning ability of electric toothbrushes on teeth is an urgent problem to be solved.

### SUMMARY

The present disclosure provides a control method of an electric toothbrush and the electric toothbrush. The electric toothbrush and the control method of the electric toothbrush enable a cleaning component thereof (i.e. a brush head) to perform combined motion in two different directions to clean the oral cavity, thereby improving the cleaning ability of the electric toothbrush on teeth.

In a first aspect, the present disclosure provides the electric toothbrush. The electric toothbrush comprises a handle, a circuit board, a bidirectional motor, and a brush head. The circuit board is connected to the bidirectional motor. The circuit board and the bidirectional motor are disposed in the handle. The bidirectional motor is connected to the brush head. The circuit board is configured to output a first driving signal and a second driving signal. The bidirectional motor is configured to drive the brush head to generate a first motion relative to the handle based on the first driving signal and is configured to drive the brush head to generate a second motion relative to the handle based on the second driving signal. A motion direction of the first motion is different from a motion direction of the second motion. The circuit board simultaneously outputs the first driving signal and the second driving signal, so that the brush head performs a combined motion of the first motion and the second motion.

In a second aspect, the present disclosure provides the electric toothbrush. The electric toothbrush comprises a processor and a memory.

The memory is configured to store computer programs, and the processor is configured to invoke the computer programs, so that the electric toothbrush executes the control method in the second aspect or a possible Implementation of the control method in the second aspect.

The electric toothbrush of the present disclosure comprises the handle, the circuit board, the bidirectional motor, and the brush head. The circuit board is connected to the bidirectional motor. The circuit board and the bidirectional motor are disposed in the handle. The bidirectional motor is connected to the brush head. The circuit board is configured to output the first driving signal and the second driving signal. The bidirectional motor is configured to drive the brush head to generate the first motion relative to the handle based on the first driving signal and is configured to drive the brush head to generate the second motion relative to the handle based on the second driving signal. The motion direction of the first motion is different with the motion direction of the second motion. The circuit board simultaneously outputs the first driving signal and the second driving signal, so that the brush head performs the combined motion of the first motion and the second motion. Since the circuit board simultaneously outputs the first driving signal and the second driving signal, the bidirectional motor drives the brush head to generate the first motion based on the first driving signal and drives the brush head to generate the second motion based on the second driving signal. That is, the bidirectional motor drives the brush head to move in two different directions (i.e., the first motion and the second motion), thereby realizing the combined motion of the brush head in two different directions. Therefore, when the brush head is used for oral cleaning, the brush head applies a peeling force to soft plaque or dental plaque on surfaces of the teeth in multiple directions, so that the soft plaque or the dental plaque on the surfaces of the teeth is easier to clean, thereby improving the cleaning ability of the electric toothbrush on the teeth. Thus, the electric toothbrush solves a problem of poor oral cleaning effect caused by the single motion of a conventional brush head for cleaning the oral cavity. As a result, when the brush head performs the combined motion in two different directions for oral cleaning, the cleaning ability of the electric toothbrush on the teeth is significantly improved.

In the control method of the electric toothbrush of the present disclosure, the oral cleaning instruction is obtained, the first driving signal and the second driving signal corresponding to the oral cleaning instruction are determined in response to the oral cleaning instruction, then the cleaning component is controlled to generate the first motion based on the first driving signal, and the cleaning component is controlled to generate the second motion based on the second driving signal. A motion direction of the first motion is different from a motion direction of the second motion. The first driving signal and the second driving signal are simultaneously output to enable the cleaning component to perform the combined motion of the first motion and the second motion. By simultaneously outputting the first driving signal and the second driving signal, the cleaning component outputs two motions in different directions (i.e., the first motion and the second motion), thereby enabling the cleaning component to performs the combined motion of the first motion and the second motion. Therefore, when the cleaning component is used for oral cleaning, the cleaning component applies a peeling force to the soft plaque or the dental plaque on the surfaces of the teeth in multiple directions, so that the soft plaque or the dental plaque on the surfaces of the teeth is easier to clean, thereby improving the cleaning ability of the electric toothbrush on the teeth. Thus, the electric toothbrush solves the problem of poor oral cleaning effect caused by the single motion of the conventional cleaning component for cleaning the oral cavity. As a result, when the cleaning component performs the combined motion in two different directions for oral cleaning, the cleaning ability of the electric toothbrush on the teeth is significantly improved.

### BRIEF DESCRIPTION OF DRAWINGS

FIG. 1 is a structural schematic diagram of an electric toothbrush according to one embodiment of the present disclosure.

FIG. 2 is a schematic diagram of a motion path of an acoustic-type toothbrush and a motion path of a rotary-type electric toothbrush on teeth according to one embodiment of the present disclosure.

FIG. 3 is a structural schematic diagram of the electric toothbrush according to another embodiment of the present disclosure.

FIG. 4 is a schematic diagram showing a motion directions of a first motion and a motion direction of a second motion according to one embodiment of the present disclosure.

FIG. 5 is a schematic diagram of a system of the electric toothbrush according to one embodiment of the present disclosure.

FIG. 6 is a schematic diagram of a projection curve of the electric toothbrush moving on teeth according to one embodiment of the present disclosure.

FIG. 7 is a schematic diagram of driving mechanisms and output shafts of a bidirectional motor according to one embodiment of the present disclosure.

FIG. 8 is a schematic diagram of the system of the electric toothbrush according to another embodiment of the present disclosure.

FIG. 9 is a schematic diagram of the system of the electric toothbrush according to another embodiment of the present disclosure.

FIG. 10 is a flow chart of a control method of the electric toothbrush according to one embodiment of the present disclosure.

FIG. 11 is a flow chart of the control method of the electric toothbrush according to another embodiment of the present disclosure.

FIG. 12 is a flow chart of a control device of the electric toothbrush according to one embodiment of the present disclosure.

FIG. 13 is a structural schematic diagram of the electric toothbrush according to one embodiment of the present disclosure.

### DETAILED DESCRIPTION

The following clearly describes the technical solutions in the present disclosure with reference to the accompanying drawings. In the description of the embodiments of the present disclosure, unless otherwise stated, “/” means “or”. For example, A/B may represent A or B. “and/or” in the text is merely an association relationship for describing associated objects, indicating that three relationships may exist. For example, the limitation “A and/or B” may indicate that A exists alone, both A and B exist, and B exists alone. In addition, in the description of the embodiments of the present disclosure, “a plurality of” and “multiple” means that the corresponding quantity is two or more than two.

In addition, terms such as “first” and “second” are only used for the purpose of description, rather than being understood to indicate or imply relative importance or hint the number of indicated technical features. Thus, the feature limited by “first” and “second” can explicitly or impliedly comprise one or more features.

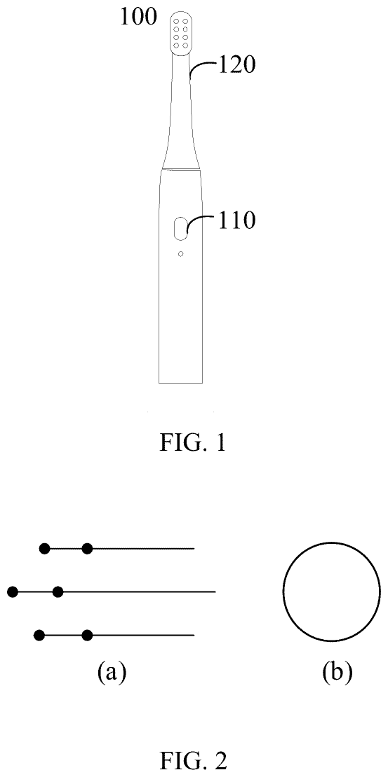

FIG. 1 is a structural schematic diagram of an electric toothbrush according to one embodiment of the present disclosure.

For instance, as shown in FIG. 1, the electric toothbrush 100 is provided, and the electric toothbrush 100 comprises at least a control button 110 and a brush head (also referred to as a “cleaning component”) 120. The electric toothbrush 100 is a device for oral cleaning, a dental cleaning instrument, etc.

The control button 110 is configured to receive an oral cleaning instruction triggered by a user, and transmit the oral cleaning instruction to a circuit board (also referred to as a “control unit”) disposed in the electric toothbrush. When the circuit board receives the oral cleaning instruction, the circuit board controls the brush head 120 to swing and/or move through the oral cleaning instruction. The control unit may be other devices that is able to respond to the oral cleaning instruction to control the brush head 120 to swing and/or move and is not limited to the circuit board.

The brush head 120 is able to swing and/or move according to control of the circuit board, thereby decomposing toothpaste pasted on the brush head 120, so that the toothpaste is decomposed into fine foam to clean teeth. Optionally, the brush head 120 may comprise, but is not limited to, a head portion and bristles of the electric toothbrush.

As shown in FIG. 1, the circuit disposed in an accommodating cavity defined by a handle and may be a microcontroller unit (MCU). The MCU is also known as a single-chip microcomputer or a single chip. The MCU appropriately reduces a frequency and specifications of a central process unit (CPU), and integrates peripheral interfaces such as memory, counter, USB, A/D conversion, universal asynchronous receiver/transmitter (UART), programmable logic controller (PLC), data memory access (DMA), and even liquid crystal display (LCD) drive circuits on a single chip to form a chip-level computer, which performs different combination controls for different application scenarios.

In the related art, electric toothbrushes are mainly divided into rotary-type electric toothbrushes and sonic electric toothbrushes. Rotary-type electric toothbrushes mainly scrape the teeth by rotating a brush head thereof for tooth cleaning; while sonic electric toothbrushes mainly clean the teeth by high-frequency vibration of the brush head. As shown in (a) of FIG. 2, a projection of a motion path of the sonic electric toothbrushes on the teeth presents straight lines when cleaning the teeth. As shown in (b) of FIG. 2, a projection of a motion path of the rotary-type electric toothbrushes on the teeth presents a circle when cleaning the teeth.

Specifically, the sonic electric toothbrushes clean the teeth laterally, and the sonic electric toothbrushes have a relatively simple motion mode, which limits a cleaning ability on the teeth. Especially the sonic electric toothbrushes have a poor cleaning effect on a gum line, dead corners, pits, and fissures, and cannot meet a demand of a user for cleaning the teeth. In addition, a rotary motion of the rotary-type electric toothbrushes is generated by mechanical transmission with a low motion frequency. Therefore, the rotary-type electric toothbrushes have a low cleaning force on soft plaque or dental plaque on the teeth, resulting in a poor cleaning effect of the rotary-type electric toothbrushes on the soft plaque or the dental plaque on the teeth.

In order to solve a problem that the sonic electric toothbrushes and the rotary-type electric toothbrushes have poor cleaning effects on the teeth, the present disclosure provides a control method of an electric toothbrush, a control device of the electric toothbrush, the electric toothbrush, and a storage medium.

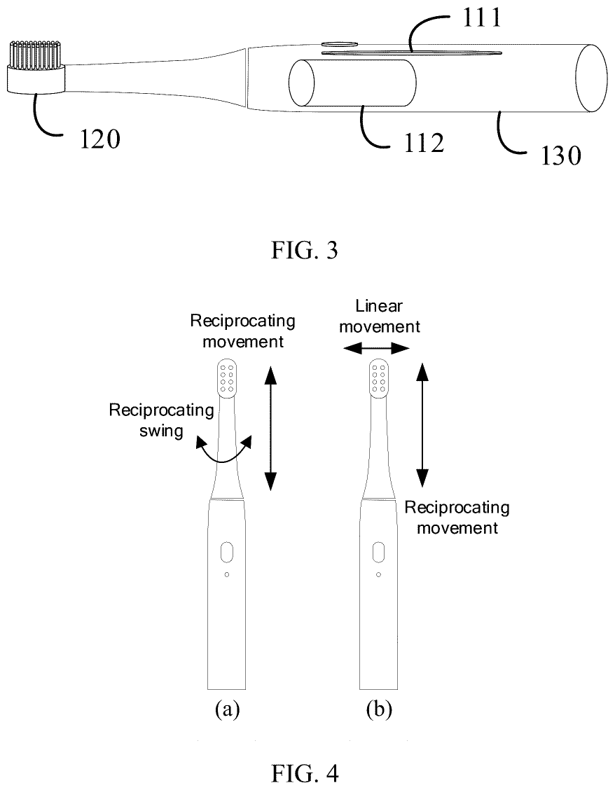

The electric toothbrush provided by embodiments of the present disclosure is described in detail below with reference to FIGS. 3-9.

FIG. 3 is a structural schematic diagram of the electric toothbrush according to another embodiment of the present disclosure.

Specifically, as shown in FIG. 3, the electric toothbrush 100 comprises a handle 130, a circuit board 111, a bidirectional motor 112, and a brush head 120. The circuit board 111 is connected to the bidirectional motor 112. The bidirectional motor 112 is connected to the brush head 120. The circuit board 111 and the bidirectional motor 112 are disposed in the handle 130.

The circuit board 111 is configured to output two driving signals, for example, a first driving signal and a second driving signal, according to an oral cleaning instruction triggered by the user. The control button 110 shown in FIG. 1 is connected to the circuit board 111 to transmit the oral cleaning instruction triggered by the user to the circuit board 111.

Optionally, the oral cleaning instruction is triggered by the user through the control button of the electric toothbrush 100, and a triggering method comprises, but is not limited to touch, press, voice, etc. In addition, the oral cleaning instruction carries oral cleaning parameters required by the electric toothbrush 100 for oral cleaning, such as oral cleaning modes, oral cleaning intensities, etc., which is not limited thereto.

For instance, when the user needs to clean the oral cavity, the user is able to press the control button of the electric toothbrush 100 to trigger the oral cleaning instruction. Alternatively, the user is able to send the oral cleaning instruction to the electric toothbrush 100 through a smart terminal connected to the electric toothbrush 100, so that the circuit board 111 receives the oral cleaning instruction for oral cleaning.

The bidirectional motor 112 is configured to drive the brush head 120 to generate a first motion relative to the handle 130 based on the first driving signal output by the circuit board 111. Moreover, the bidirectional motor 112 is configured to drive the brush head 120 to generate a second motion relative to the handle 130 based on the second driving signal output by the circuit board 111 A motion direction of the first motion is different from a motion direction of the second motion.

Optionally, The first motion represents a reciprocating swing of the brush head 120 with a length extending direction of the brush head 120 as an axis (such as reciprocating swing shown in (a) of FIG. 4). That is, first motion is to perform arc swings, which generate a longitudinal scraping force on the teeth when the brush head 120 cleans the teeth and peel off the soft plaque or the dental plaque on surfaces of the teeth.

Optionally, the second motion represents a reciprocating movement along the length extending direction of the brush head 120 (such as the reciprocating movement shown in (a) of FIG. 4). That is, the second motion is to perform linear vibrations, which generate a lateral scraping force when the brush head 120 cleans the teeth and peel off the soft plaque or dental plaque on the surface of the teeth.

Furthermore, as shown in (a) of FIG. 4, the combined motion of the first motion and the second motion is a composite motion including arc swing and linear vibration (i.e., arc motion). The arc motion replaces a brushing method of the user manually using an ordinary toothbrush (not the electric toothbrush 100) by rotating the brush head while moving the brush head. That is, the combined motion performed by the brush head 120 realizes the same brushing method as an arc brushing method, so that when the brush head cleans the teeth through the combined motion, the teeth are cleaned through both the arc swing and the linear vibration. In other words, the brush head 120 cleans the teeth laterally and longitudinally at the same time, so that the soft plaque or the dental plaque on the surfaces of the teeth is more easily peeled off under multi-directional scraping. In addition, a mechanical motion of the brush head 120 helps the user to clean the oral cavity better and avoids a problem of an oral cleaning effect being affected by individual operation differences of different users, so that any user is allowed to use the electric toothbrush 100 to achieve a more effective cleaning of the teeth by the arc brushing method.

Optionally, the first motion may also represent a reciprocating movement of the brush head 120 with the length extending direction of the brush head 120 as the axis (such as a linear motion as shown in (b) in FIG. 4).

For instance, correspondences between oral cleaning parameters, the first driving signal and the second driving signal are pre-stored in the electric toothbrush 100, so that after receiving the oral cleaning instruction, the circuit board responds to the oral cleaning instruction and queries the first driving signal and the second driving signal corresponding to the oral cleaning instruction from the correspondences according to the oral cleaning parameters carried by the oral cleaning instruction. Then, the circuit board drives the brush head to generate reciprocating swings with the length extending direction of the brush head as the axis based on the first driving signal and drives the brush head to generate reciprocating movement along the length extending direction of the brush head based on the second driving signal.

Alternatively, the circuit board responds to the oral cleaning instruction and queries the first driving signal and the second driving signal corresponding to the oral cleaning instruction from the correspondences according to the oral cleaning parameters carried by the oral cleaning instruction. The circuit board drives the brush head to generate reciprocating movement with the length extending direction of the brush head as the axis based on the first driving signal and drives the brush head to generate reciprocating movement along the length extending direction of the brush head based on the second driving signal.

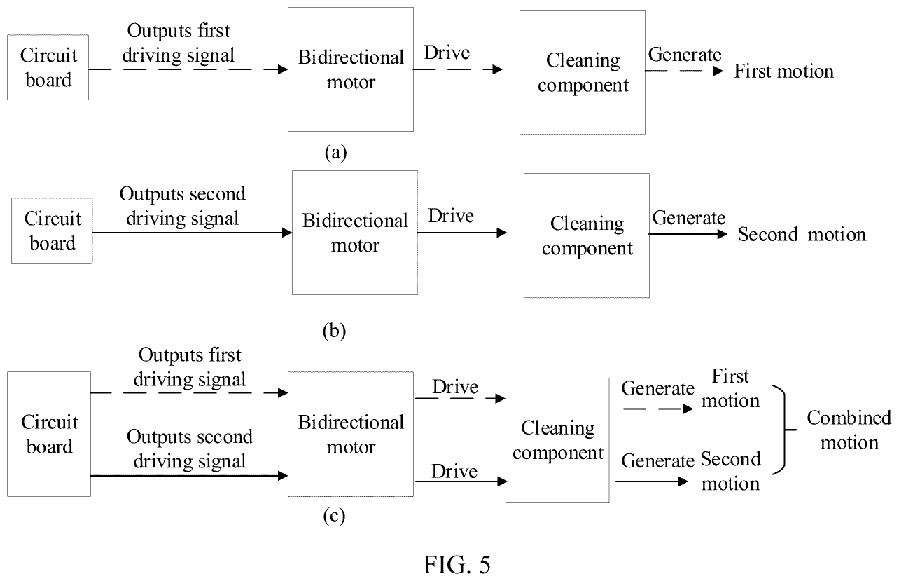

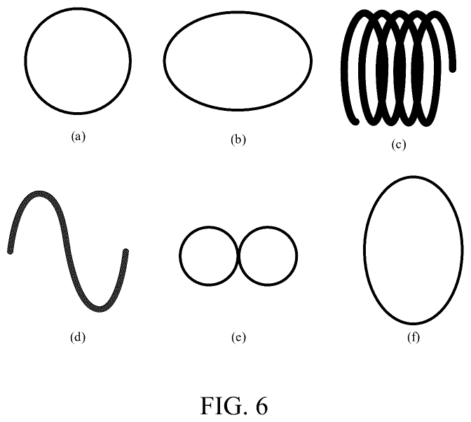

FIG. 5 is a schematic diagram of a system of the electric toothbrush according to one embodiment of the present disclosure.

As shown in (a) in FIG. 5, the circuit board 111 simultaneously outputs the first driving signal and the second driving signal, so that the brush head 120 performs a combined motion of the first motion and the second motion.

An electric toothbrush in (a) of FIG. 5 comprises the circuit board, the bidirectional motor, and the brush head. The circuit board is configured to output the first driving signal to the bidirectional motor according to the oral cleaning instruction triggered by the user. The bidirectional motor is configured to drive the brush head to generate the first motion according to the first driving signal.

Specifically, when the circuit board receives the oral cleaning instruction triggered by the user, the circuit board outputs the first driving signal to the bidirectional motor to drive the bidirectional motor to drive the brush head to generate the first motion (as shown in (a) in FIG. 5). When the bidirectional motor drives the brush head to generate the first motion, the brush head applies a longitudinal peeling force to the soft plaque or the dental plaque on the surfaces of the teeth, thereby longitudinally cleaning the soft plaque or the dental plaque on the surfaces of the teeth.

Specifically, the circuit board shown in (b) of FIG. 5 is configured to output a second driving signal to the bidirectional motor according to the oral cleaning instruction triggered by the user. The bidirectional motor is configured to drive the brush head to generate the second motion having the motion direction being different from the motion direction of the first motion according to the second driving signal.

Specifically, when the circuit board receives the oral cleaning instruction triggered by the user, the circuit board outputs the second driving signal to the bidirectional motor to drive the bidirectional motor to drive the brush head to generate the second motion (as shown in (b) in FIG. 5). When the bidirectional motor drives the brush head to generate the second motion, the brush head applies a horizontal peeling force to the soft plaque or the dental plaque on the surfaces of the teeth, thereby laterally cleaning the soft plaque or the dental plaque on the surfaces of the teeth.

It should be noted that a motor in the embodiments of the present disclosure is not limited to the bidirectional motor, but may also be a three-way motor or other multi-directional motor. A type of the multi-directional motor is determined according to the requirements of moving directions of the brush head, which is not limited thereto.

Specifically, when the circuit board outputs the first driving signal and the second driving signal at the same time, the bidirectional motor drives the brush head to generate the first motion based on the first driving signal while driving the brush head to generate the second motion based on the second driving signal, so that the brush head performs the combined motion of the first motion and the second motion (as shown in (a) in FIG. 4, or as shown in (b) in FIG. 4). That is, the brush head performs the arc motion to clean the oral cavity.

As shown in (c) of FIG. 5, when the circuit board receives the oral cleaning instruction triggered by the user, the circuit board simultaneously outputs the first driving signal and the second driving signal to the bidirectional motor, so that the bidirectional motor simultaneously drives the brush head to generate the first motion and the second motion that have different motion directions, so that the brush head performs the combined motion of high-frequency vibration. When the teeth are scraped in all directions under the high-frequency vibration, the soft plaque and the dental plaque on the teeth are easier to clean, thereby improving a cleaning power of the brush head. In addition, when the brush head cleans the teeth through the arc motion, the brush head smoothly scrapes the surfaces of the teeth or positions where the teeth meet the gums, thereby avoiding damage to the gums due to straight scraping while massaging the gums to avoid gum atrophy.

For instance, since at least one of a duration of the first driving signal output by the circuit board and a duration of the second driving signal output by the circuit board, a duty ratio of the first driving signal and a duty ratio of the second driving signal, a vibration frequency of the first motion and a vibration frequency of the second motion, a driving frequency of the first motion and a driving frequency of the second motion, and a swing amplitude of the first motion and a movement amplitude of the second motion affects a projection of the brush head on the teeth when the brush head performs the arc motion on the teeth. As a result, a shape of the projection of the brush head on the teeth when the brush head performs the arc motion may comprise but is not limited to shapes shown in FIG. 6. For example, the projection of the brush head is a circle as shown in (a) of FIG. 6, an ellipse as shown in (b) of FIG. 6, a spring-shaped curve as shown in (c) of FIG. 6, a sine-shaped curve as shown in (d) of FIG. 6, a lying 8-shaped curve as shown in (e) of FIG. 6, or an ellipse as shown in (f) of FIG. 6.

It should be noted that the projections of the electric toothbrush moving on the teeth shown in FIG. 6 are respectively projections of one complete motion of the brush head.

Optionally, when the user uses the electric toothbrush to clean the oral cavity, a movement of the electric toothbrush on the teeth may also affect the projection of the brush head For example, when the user moves the electric toothbrush laterally while brushing the teeth, the projection of the combined motion of the brush head on the teeth may change. For instance, the projection of the brush head on the teeth may change from the circle shown in (a) of FIG. 6 to the spring-shaped curve shown in (c) of FIG. 6. Alternatively, the projection of the brush head on the teeth may change from the ellipse shown in (b) of FIG. 6 to the spring-shaped curve shown in (c) of FIG. 6. Alternatively, the projection of the brush head on the teeth may change from the ellipse shown in (f) of FIG. 6 to the spring-shaped curve shown in (c) of FIG. 6.

In the electric toothbrush shown in FIG. 3, since the circuit board outputs the first driving signal and the second driving signal at the same time, the bidirectional motor drives the brush head to generate the first motion based on the first driving signal, and drives the brush head to generate the second motion based on the second driving signal. That is, the bidirectional motor drives the brush head to move in two different directions (i.e., the first motion and the second motion), thereby realizing the combined motion of the brush head in two different directions. Therefore, when the brush head cleans the oral cavity, the brush head applies the peeling force to the soft plaque or the dental plaque on the surfaces of the teeth in multiple directions, making the soft plaque or the dental plaque on the surfaces of the teeth easier to clean, improving the cleaning ability of the electric toothbrush on the teeth, and avoiding the problem of poor oral cleaning effect caused by the single motion of the conventional brush head to clean the oral cavity. Therefore, when the brush head performs the combined motion in two different directions to clean the oral cavity, the cleaning ability of the electric toothbrush on the teeth is improved.

Optionally, the electric toothbrush may comprise with but not limited to at least one indicator lights, at least one button, at least one display screen, at least one speaker, at least one motor, etc.

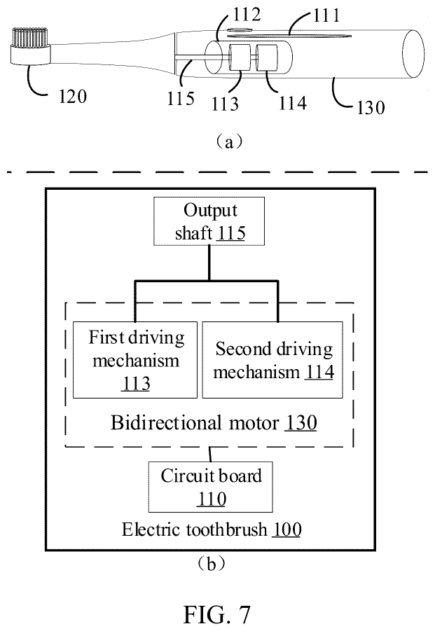

Exemplarily, the bidirectional motor 112 comprises driving mechanisms and output shafts. For example, the bidirectional motor 112 comprises the first driving mechanism 113, the second driving mechanism 114, and an output shaft 115 shown in (a) of FIG. 7. The first driving mechanism 113 and the second driving mechanism 114 share the output shaft 115 (which is referred to the “third output shaft”), and the output shaft 115 is an integrated structure. The output shaft 115 is connected to the first driving mechanism 113 and the second driving mechanism 114, respectively, and the output shaft 115 is connected to the brush head 120, so that the first driving mechanism 113 and the second driving mechanism 114 are both connected to the brush head 120.

Optionally, a connection relationship shown in (a) in FIG. 7 is more clearly understood through (b) in FIG. 7, where the circuit board 110 is connected to the bidirectional motor 130, the bidirectional motor 130 comprises the first driving mechanism 113 and the second driving mechanism 114, and the first driving mechanism 113 and the second driving mechanism 114 are connected to the output shaft 115.

The first driving mechanism 113 is configured to drive the brush head 120 to generate the first motion based on the first driving signal.

The second driving mechanism 114 is configured to drive the brush head 120 to generate the second motion based on the second driving signal.

Exemplarily, when the circuit board 111 outputs the first driving signal, the first driving mechanism 113 drives the brush head 120 to generate the first motion based on the first driving signal.

Exemplarily, when the circuit board 111 outputs the second driving signal, the second driving mechanism 114 drives the brush head 120 to generate the second motion having the motion direction different from that of the first motion based on the second driving signal, so that the brush head perform cleaning motions in different directions.

It should be noted that shapes of the first driving mechanism 113 and the second driving mechanism 114 shown in FIG. 7 are for illustrative purpose only, and the shapes of the first driving mechanism 113 and the second driving mechanism 114 may also be rectangular or irregular, which are not limited thereto.

It should also be noted that the number of driving mechanisms in the bidirectional motor is not limited in the embodiment, and the number of driving mechanisms is determined according to direction requirements for the brush head. For example, the number of driving mechanisms in the bidirectional motor is 1, 3, or 4, which is not limited thereto.

The output shaft 115 is configured to drive the brush head 120 to perform the first motion under the first driving signal.

The output shaft 115 is further configured to drive the brush head 120 to perform the second motion under the second driving signal.

Specifically, the circuit board 111 outputs the first driving signal to the first drive mechanism 113, and the first drive mechanism 113 drives the output shaft 115 to perform the first motion based on the first driving signal, so as to drive the brush head 120 to perform the first motion. Therefore, the brush head forms a longitudinal scraping force during the cleaning process of the teeth to peel off the soft plaque or the dental plaque on the surfaces of the teeth.

In addition, the circuit board 111 further outputs the second driving signal to the second driving mechanism 114. The second driving mechanism 114 drives the output shaft 115 to perform the second motion based on the second driving signal, so as to drive the brush head 120 to perform the second motion. Therefore, the brush head forms the lateral scraping force during the cleaning process of the teeth to peel off the soft plaque or the dental plaque on the surfaces of the teeth.

Furthermore, when the circuit board 111 simultaneously outputs the first driving signal to the first drive mechanism 113 and the second driving signal to the second drive mechanism 114, the first drive mechanism 113 and the second drive mechanism 114 drive the output shaft 115 to perform the combined motion of the first motion and the second motion based on the first driving signal and the second driving signal respectively, thereby driving the brush head 120 to perform the combined motion. Therefore, the brush head 120 applies the peeling force to the soft plaque or the dental plaque on the surfaces of the teeth in multiple directions, so that the soft plaque or the dental plaque on the surfaces of the teeth is easier to clean, thereby improving the cleaning ability of the electric toothbrush on the teeth.

Optionally, the output shaft 115 may also be a separated structure. Namely, the output shaft 115 is divided into output shafts, such as a first output shaft and a second output shaft. The first output shaft is different from the second output shaft. The first drive mechanism 113 and the second drive mechanism 114 have corresponding output shafts. For example, the first drive mechanism 113 corresponds to the first output shaft, and the second drive mechanism 114 corresponds to the second output shaft.

The first output shaft is connected to the first drive mechanism 113, the second output shaft is connected to the second drive mechanism 114, and the first output shaft and the second output shaft are connected through a connecting piece. The first output shaft and the second output shaft are connected to the brush head 120.

The first output shaft is configured to drive the brush head 120 to perform the first motion under the first driving signal.

The second output shaft is further configured to drive the brush head 120 to perform the second motion under the second driving signal.

Specifically, the circuit board 111 outputs the first driving signal to the first drive mechanism 113, and the first drive mechanism 113 drives the first output shaft to perform the first motion based on the first driving signal, so as to drive the brush head 120 to perform the first motion. Therefore, the brush head forms the longitudinal scraping force during the cleaning process of the teeth to peel off the soft plaque or the dental plaque on the surfaces of the teeth.

In addition, the circuit board 111 further outputs the second driving signal to the second driving mechanism 114. The second driving mechanism 114 drives the second output shaft to perform the second motion based on the second driving signal, so as to drive the brush head 120 to perform the second motion. Therefore, the brush head forms the lateral scraping force during the cleaning process of the teeth to peel off the soft plaque or the dental plaque on the surfaces of the teeth.

Furthermore, when the circuit board 111 simultaneously outputs the first driving signal to the first drive mechanism 113 and the second driving signal to the second drive mechanism 114, the first drive mechanism 113 and the second drive mechanism 114 respectively drive the first output shaft and the second output shaft to perform the combined motion of the first motion and the second motion based on the first driving signal and the second driving signal, thereby driving the brush head 120 to perform the combined motion. Therefore, the brush head 120 applies the peeling force to the soft plaque or the dental plaque on the surfaces of the teeth in multiple directions, so that the soft plaque or the dental plaque on the surfaces of the teeth is easier to clean, thereby improving the cleaning ability of the electric toothbrush on the teeth.

Optionally, the number of the output shafts of the bidirectional motor 112 is the same as the number of the driving mechanisms of the bidirectional motor 112.

In one optional embodiment, the first driving mechanism 113 is configured to drive the brush head 120 to swing in the reciprocating manner with the length extending direction of the brush head 120 as the axis based on the first driving signal; or the first driving mechanism 113 is configured to drive the brush head 120 to reciprocate with the length extending direction of the brush head 120 as the axis based on the first driving signal. The second driving mechanism 114 is configured to drive the brush head 120 reciprocate along the length extending direction of the brush head 120 based on the second driving signal.

Specifically, the circuit board 111 outputs a driving signal corresponding to the first driving mechanism 113 (i.e., the first driving signal) to the first driving mechanism 113, and drive the brush head 120 to generate the first motion through the bidirectional motor 112. That is, the brush head 120 is driven to swing in the reciprocating manner with the length extending direction of the brush head 120 as the axis, so that the brush head forms the longitudinal scraping force during the cleaning process of the teeth, thereby peeling off the soft plaque or the dental plaque on the surfaces of the teeth.

Further, the circuit board 111 outputs a driving signal corresponding to the second driving mechanism 114 (i.e., the second driving signal) to the second driving mechanism 114, and drive the brush head 120 to generate the second motion through the bidirectional motor 112. That is, the brush head 120 is driven to move in the reciprocating manner along the length extending direction of the brush head 120, so that the brush head forms the horizontal scraping force during the cleaning process of the teeth, thereby peeling off the soft plaque or the dental plaque on the surfaces of the teeth.

Alternatively, the circuit board 111 may output the driving signal corresponding to the first driving mechanism 113 (i.e., the first driving signal) to the first driving mechanism 113, and drive the brush head 120 to reciprocate with the length extension direction of the brush head 120 as the axis through the bidirectional motor.

Optionally, the first driving mechanism 113 and the second driving mechanism 114 may work simultaneously or separately.

Optionally, The circuit board 111 is allowed to simultaneously output the first driving signal to the first drive mechanism 113 and the second driving signal to the second drive mechanism 114, so that the first drive mechanism 113 and the second drive mechanism 114 work simultaneously, thus driving the brush head 120 to generate the combined motion of the first motion and the second motion. The projection of the combined motion on the teeth is arc, that is, the combined motion is an arc motion. Because the brush head performs the arc motion generated by signal transmission, a motion frequency of the brush head is much greater than a motion frequency of a rotational motion generated by mechanical transmission of the brush head, thereby improving the cleaning force of the brush head, making the brush head easier to clean the soft plaque and the dental plaque on the teeth when the brush head brushes the teeth in different directions under high-frequency vibration. In addition, because the brush head cleans the teeth through the arc motion, the brush head smoothly scrapes the surfaces of the teeth or the positions where the teeth meet the gums, thereby avoiding damage to the gums due to straight scraping and massaging the gums to avoid gum atrophy.

Optionally, the circuit board 111 may output a single motion (one of the first motion and the second motion) and a combined motion alternately. For example, the first driving signal is output to the first drive mechanism 113 separately, and after the output of the first driving signal is completed, the first driving signal is output to the first drive mechanism 113 and the second driving signal is output to the second drive mechanism 114 simultaneously. Alternatively, the second driving signal is output to the second drive mechanism 114 separately, and after the output of the second driving signal is completed, the first driving signal is output to the first drive mechanism 113 and the second driving signal is output to the second drive mechanism 114 simultaneously.

Optionally, the circuit board 111 may output the first motion and the second motion alternately. For instance, the first driving signal is output to the first drive mechanism 113 separately. After the output of the first driving signal is completed, the second driving signal is output to the second drive mechanism 114 separately. After the output of the second driving signal is completed, the first driving signal is output to the first drive mechanism 113 separately.

Optionally, the circuit board 111 may output the first driving signal to the first drive mechanism 113 separately, so that the brush head 120 only generates the first motion. After the output of the first driving signal is completed, the circuit board 111 outputs the second driving signal to the second drive mechanism 114 separately, so that the brush head 120 only generates the second motion.

It should be noted that the single motion is the first motion or the second motion. Further, a timing of the circuit board 111 outputting the first driving signal and the second driving signal separately is not fixed. That is, the circuit board 111 is allowed to output the first driving signal first and then the second driving signal, or the circuit board 111 is allowed to output the second driving signal first and then the first driving signal; which is not limited in the present disclosure.

In one optional embodiment, the first drive mechanism and the second drive mechanism disposed in the handle of the electric toothbrush are disposed along an extending direction of the handle.

For instance, as shown in FIG. 7, the handle 130 comprises the circuit board 111 and the bidirectional motor 112. Since the first drive mechanism 113 and the second drive mechanism 114 are disposed inside the bidirectional motor 112, the first drive mechanism 113 and the second drive mechanism 114 are also disposed in the handle 130. Moreover, the first drive mechanism 113 and the second drive mechanism 114 are disposed along the extending direction of the handle 130 as shown in FIG. 7, so that the first drive mechanism 113 and the second drive mechanism 114 drive the brush head 120 to move without affecting each other, ensuring that the brush head being capable of performing the combined motion.

Exemplarily, vibration frequencies of the brush head in different directions also affect the cleaning effect on the teeth. Therefore, the vibration frequency of the first motion and the vibration frequency of the second motion is configured in advance.

Optionally, the vibration frequency of the first motion is equal to the vibration frequency of the second motion. When the vibration frequency of the first motion is equal to the vibration frequency of the second motion, a trajectory of the projection of the combined motion of the brush head on the teeth is more regular and closer to a circle, such as the circle shown in (a) in FIG. 6, thereby improving the cleaning ability of the brush head on the soft plaque or the dental plaque on the surfaces of the teeth and realizing a deeper cleaning of the teeth.

Optionally, the vibration frequency of the first motion is different from the vibration frequency of the second motion. For example, the vibration frequency of the first motion is greater than the vibration frequency of the second motion. When the vibration frequency of the first motion is greater than the vibration frequency of the second motion, the trajectory of the projection of the combined motion of the brush head on the teeth presents the spring-shaped curve as shown in (c) of FIG. 6 or a sine-shaped curve as shown in (d) of FIG. 6. That is, the brush head moves while shaking, which is equivalent to a brushing action of the user moving and shaking up and down when brushing manually. In addition, since the vibration frequency of the first motion is greater than the vibration frequency of the second motion, the longitudinal scraping force applied by the brush head to the soft plaque or dental plaque on the surfaces of the teeth is greater than the lateral scraping force, making the soft plaque and the dental plaque on the surfaces of the teeth easier to clean.

Furthermore, driving frequencies of the driving signals output by the circuit board also affect the vibration frequency of the brush head, so the circuit board adjust the vibration frequency of the first motion and the vibration frequency of the second motion by changing a driving frequency of the first driving signal and a driving frequency of the second driving signal. For example, when the driving frequency of the first driving signal is greater than the driving frequency of the second driving signal, the vibration frequency of the first motion is greater than the vibration frequency of the second motion. Alternatively, when the driving frequency of the first driving signal is not greater than the driving frequency of the second driving signal, the vibration frequency of the first motion is not greater than the vibration frequency of the second motion.

Further, when the vibration frequency of the first motion is greater than the vibration frequency of the second motion, the vibration frequency of the first motion may be not less than twice the vibration frequency of the second motion.

For instance, the circuit board may output the vibration frequency of the first motion not less than twice the vibration frequency of the second motion. When the vibration frequency of the first motion is not less than twice the vibration frequency of the second motion, the longitudinal scrapping force applied by the brush head to the soft plaque and the dental plaque on the surfaces of the teeth is much greater than the lateral scrapping force, so as to perform a deeper cleaning of the soft plaque and the dental plaque on the surfaces of the teeth.

Optionally, when the driving frequency of the first driving signal is greater than the driving frequency of the second driving signal, the driving frequency of the first driving signal is not less than twice the driving frequency of the second driving signal.

For instance, since the driving frequencies of the driving signals output by the circuit board affect the vibration frequency of the brush head, when the driving frequency of the first driving signal is not less than twice the driving frequency of the second driving signal, the vibration frequency of the first motion is not less than twice the vibration frequency of the second motion, so that the longitudinal scrapping force applied by the brush head to the soft plaque and the dental plaque on the surfaces of the teeth is much greater than the lateral scrapping force, so as to perform a deeper cleaning of the soft plaque and the dental plaque on the surfaces of the teeth.

Specifically, in addition to the vibration frequency of the brush head in different directions affecting the cleaning effect of the teeth, swing amplitudes of the brush head in different directions also affect the cleaning effect of the teeth. Therefore, a swing amplitude of the first motion and a movement amplitude of the second motion are adjusted by the circuit board.

Optionally, the swing amplitude of the first motion is not greater than the movement amplitude of the second motion, and/or, a duty ration of the first driving signal is not greater than a duty ratio of the second driving signal.

For instance, when the vibration frequency of the first motion is equal to the vibration frequency of the second motion, the swing amplitude of the first motion is equal to the movement amplitude of the second motion (i.e., the vibration frequency of the first motion is equal to the vibration frequency of the second motion and the movement amplitude of the first motion is equal to the movement amplitude of the second motion), so that when the vibration frequency of the first motion is equal to the vibration frequency of the second motion, and the swing amplitude of the first motion is equal to the movement amplitude of the second motion, the trajectory of the projection of the combined motion of the brush head on the teeth presents as the circle as shown in (a) in FIG. 6, thereby improving the cleaning effect of the brush head on the soft plaque and the dental plaque on the surfaces of the teeth and realizing the deeper cleaning of the teeth.

In addition, when the vibration frequency of the first motion is equal to the vibration frequency of the second motion, and the swing amplitude of the first motion is also equal to the movement amplitude of the motion, if the user moves the electric toothbrush laterally while brushing the teeth, the trajectory of the projection of the combined motion of the brush head on the teeth presents the spring-shaped curve as shown in (c) in FIG. 6, thereby improving the cleaning effect of the brush head on the soft plaque and the dental plaque on the surfaces of the teeth.

Exemplarily, when the vibration frequency of the first motion is equal to the vibration frequency of the second motion, the swing amplitude of the first motion is less than the movement amplitude of the second motion (i.e., the vibration frequencies of the first motion and the second motion are the same but the movement amplitudes thereof are different). That is, an amplitude of reciprocating swings of the brush head with the length extending direction thereof as the axis is less than an amplitude of the reciprocating movement of the brush head along the length extending direction thereof, or an amplitude of the reciprocating movement of the brush head with the length extending direction thereof as the axis is less than the amplitude of the reciprocating movement of the brush head along the length extending direction thereof. In other words, when the vibration frequency of the first motion is equal to the vibration frequency of the second motion, the bidirectional motor adjusts a longitudinal swing amplitude of the brush head to be less than a lateral movement amplitude, so that the trajectory of the projection of the combined motion of the brush head on the teeth presents the ellipse as shown in (b) in FIG. 6, which avoid damage to the gums due to a large longitudinal swing amplitude of the brush head during the cleaning process, thereby protecting the gums.

Exemplarily, when the vibration frequency of the first motion is equal to the vibration frequency of the second motion, the swing amplitude of the first motion is greater than the movement amplitude of the second motion. That is, the amplitude of the reciprocating swing of the brush head with the length extending direction as the axis is greater than the amplitude of the reciprocating movement of the brush head along the length extending direction, or the amplitude of the reciprocating movement of the brush head with the length extending direction as the axis is greater than the amplitude of the reciprocating movement of the brush head along the length extending direction thereof. In other words, when the vibration frequency of the first motion is equal to the vibration frequency of the second motion, the bidirectional motor controls the longitudinal swing amplitude of the brush head on the teeth to be greater than the lateral movement amplitude, so that the trajectory of the projection of the combined motion of the brush head on the teeth presents the ellipse as shown in (f) in FIG. 6, which increases a longitudinal cleaning area of the brush head on the teeth, thereby reducing a missed area when the brush head cleans the teeth and cleaning the teeth more comprehensively.

Furthermore, since the duty ratios of the driving signals output by the circuit board may affect the movement amplitude of the brush head, a duty ratio of the first driving signal and a duty ratio of the second driving signal are controlled through the circuit board, thereby controlling the swing amplitude of the first motion and the movement amplitude of the second motion. For example, when the duty ratio of the first driving signal is not greater than the duty ratio of the second driving signal, the swing amplitude of the first motion is not greater than the movement amplitude of the second motion. Alternatively, when the duty ratio of the first driving signal is greater than the duty ratio of the second driving signal, the swing amplitude of the first motion is greater than the movement amplitude of the second motion.

Optionally, when the vibration frequency of the first motion is different from the vibration frequency of the second motion, the swing amplitude of the first motion and the movement amplitude of the second motion may have the same movement amplitude (that is, the vibration frequencies of the first motion and the second motion are different but the movement amplitudes thereof are the same). Therefore, when the vibration frequency of the first motion is not equal to the vibration frequency of the second motion and the swing amplitude of the first motion is equal to the movement amplitude of the second motion, the longitudinal peeling force and the lateral peeling force applied by the brush head to the teeth when cleaning the teeth are different, and the trajectory of the projection of the combined motion of the brush head on the teeth presents the circle as shown in (a) in FIG. 6, thereby further improving the cleaning ability of the brush head to clean the soft plaque and the dental plaque on the surfaces of the teeth and realizing the deeper cleaning of the teeth.

Optionally, when the vibration frequency of the first motion is different from the vibration frequency of the second motion, the swing amplitude of the first motion and the movement amplitude of the second motion may be different (that is, the vibration frequencies of the first motion and the second motion are different and the movement amplitudes of the first motion and the second motion are also different), so that when the vibration frequency of the first motion and the vibration frequency of the second motion are not equal, and the swing amplitude of the first motion and the movement amplitude of the second motion are not equal, the longitudinal peeling force and the lateral peeling force applied by the brush head to the teeth when cleaning the teeth are different, and an elliptical motion trajectory is formed, thereby protecting the gums when cleaning the soft plaque or the dental plaque on the surfaces of the teeth.

For example, when the vibration frequency of the first motion is greater than the vibration frequency of the second motion, the swing amplitude of the first motion may be equal to the movement amplitude of the second motion. That is, when the longitudinal peeling force applied by the brush head to the teeth during cleaning is greater than the lateral peeling force, the trajectory of the projection of the combined motion of the brush head on the teeth presents the circle as shown in (a) in FIG. 6, so as to improve the cleaning ability of the brush head on the soft plaque and the dental plaque on the surfaces of the teeth and realizing deeper cleaning of the teeth.

For another example, when the vibration frequency of the first motion is greater than the vibration frequency of the second motion, the swing amplitude of the first motion is less than the movement amplitude of the second motion. That is, when the longitudinal peeling force applied by the brush head to the teeth during cleaning is greater than the lateral peeling force, the trajectory of the projection of the combined motion of the brush head on the teeth presents the ellipse as shown in (b) in FIG. 6, thereby improving the cleaning ability of the brush head on the soft plaque and the dental plaque on the surfaces of the teeth, while avoiding damage to the gums due to the large longitudinal swing amplitude of the brush head during the cleaning process, Therefore, the gums are well protected.

It should be noted that in different oral cleaning modes, the vibration frequency of the first motion and the vibration frequency of the second motion, as well as the swing amplitude of the first motion and the movement amplitude of the second motion are determined according to cleaning needs, thereby forming a variety of movement frequencies or movement amplitudes, which leads to a variety of the movements of the brush head, thus affecting the movement trajectory of the brush head. To sum up, the electric toothbrush with a plurality of driving mechanisms may combine more oral cleaning modes to better meet the oral cleaning needs of the user.

In one optional embodiment, a predetermined time difference is defined between an output time of the first driving signal and an output time of the second driving signal.

Specifically, the predetermined time difference (i.e., the first duration) is a sum of N period duration and a quarter of a period duration, or the predetermined time difference is a sum of the N period duration and three quarters of the period duration. The period duration is a single complete output duration of the first driving signal or a single complete output duration of the second driving signal. N is an integer not less than 0. It should be understood that the period duration of the first driving signal and the period duration of the second driving signal may be the same.

Optionally, the first duration is calculated by formula (1) or formula (2):

$$First duration = period times \times period duration + \frac{1}{4} \times period duration \qquad ( 1 )$$

$$First duration = period times \times period duration + \frac{3}{4} \times period duration \qquad ( 2 )$$

For example, a duration of a single complete output of the first driving signal and a duration of a single complete output of the second driving signal is 8 seconds, and the number of the period times is 0. When calculated by Formula (1),

$$First duration = 0 \times 8 + \frac{1}{4} \times 8 = 2 seconds .$$

When calculated by Formula (2),

$$First duration = 0 \times 8 + \frac{3}{4} \times 8 = 6 seconds .$$

N is the integer not less than zero. That is, N may be 0, 1, 2 . . . N.

For example, when the bidirectional motor is reset, the brush head is driven to swing to a middle position corresponding to the first motion, and the brush head is driven to move to an extreme position corresponding to the second motion, so that the a trajectory of the combined motion of the brush head is a closed curve, which better simulates the arc motion.

Alternatively, when the bidirectional motor is reset, the brush head is driven to swing to an extreme position corresponding to the first motion, and the brush head is driven to move to a middle position corresponding to the second motion, so that the trajectory of the combined motion of the brush head is the closed curve. In other words, when the brush head performs the combined motion, one of a swing position corresponding to the first motion and a movement position corresponding to the second motion is at the middle position thereof, and the other one is at the extreme position.

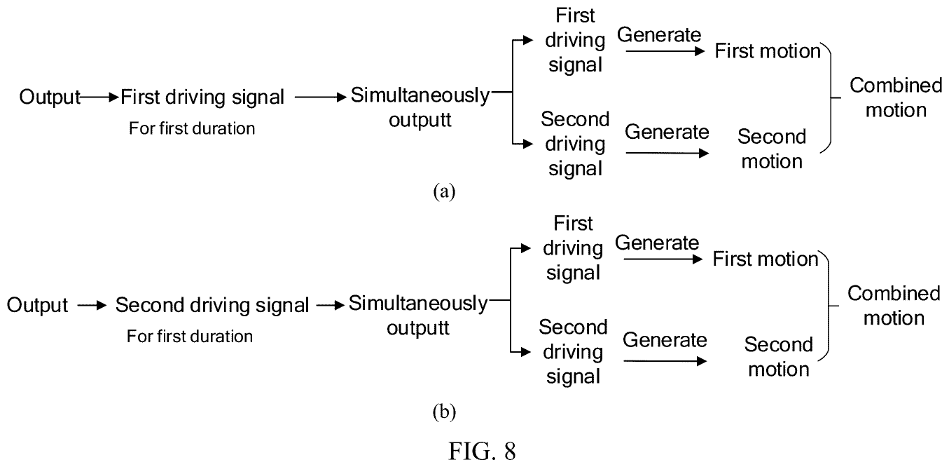

FIG. 8 is a schematic diagram of the system of the electric toothbrush according to another embodiment of the present disclosure.

For instance, as shown in (a) in FIG. 8, the circuit board of the electric toothbrush first outputs the first driving signal for a first duration (for example, 2 seconds), so that the brush head is in the middle position corresponding to the first motion or in the extreme position corresponding to the first motion. Thereafter, the first driving signal and the second driving signal are output simultaneously so that when the brush head performs the combined motion of the first motion and the second motion, there is always asynchrony between the first driving signal and the second driving signal of the first duration. That is, when the brush head performs the combined motion, one of the swing position corresponding to the first motion and a movement position corresponding to the second motion is at the middle position thereof, and the other one is at the extreme position thereof. Therefore, the projection of the trajectory of the combined motion of the brush head on the teeth is the closed curve. That is, the brush head better simulates the arc brushing method, so that a multi-directional peeling force is applied to the soft plaque or the dental plaque on the surfaces of the teeth under high-frequency vibration, making the soft plaque or the dental plaque on the surfaces easier to clean, thereby improving the cleaning ability of the electric toothbrush on the teeth.

Alternatively, as shown in (b) in FIG. 8, the circuit board of the electric toothbrush first outputs the second driving signal for the first duration (for example, 6 seconds), so that the brush head is in the middle position corresponding to the second motion or in the extreme position corresponding to the second motion. Thereafter, the first driving signal and the second driving signal are output simultaneously so that when the brush head performs the combined motion of the first motion and the second motion, there is always asynchrony between the first driving signal and the second driving signal of the first duration, thereby improving the cleaning ability of the electric toothbrush on the teeth.

It should be noted that, during the driving process of the electric toothbrush shown in (a) of FIG. 8 and (b) of FIG. 8, the vibration frequency of the first motion is equal to the vibration frequency of the second motion; and the first duration shown in (a) of FIG. 8 or (b) of FIG. 8 represents the sum of N period durations and one-quarter period duration of a single complete output of the first driving signal or the second driving signal. Alternatively, the first duration shown in (a) of FIG. 8 or (b) of FIG. 8 represents the sum of N period durations and three-quarter period durations. Moreover, the first durations shown in (a) of FIG. 8 and (b) of FIG. 8 may be the same or different. For example, the first duration shown in (a) of FIG. 8 is 2 seconds, which is different from the first duration shown in (b) of FIG. 8 of 6 seconds. When there is always the asynchrony of the first duration between the first driving signal and the second driving signal output by the circuit board, the cleaning ability of the electric toothbrush on the teeth is improved. However, the embodiments of the present disclosure are not limited thereto.

Alternatively, in addition to controlling the brush head to perform the combined motion of the first motion and the second motion, the circuit board is further capable of controlling the brush head to perform an alternating motion of a single motion and the combined motion.

For instance, the circuit board suspends outputting the first driving signal and the second driving signal, and outputs the single driving signal; then the circuit board outputs the single driving signal and simultaneously outputs the first driving signal and the second driving signal again.

Optionally, the single driving signal may be the first driving signal or the second driving signal.

Exemplarily, when the first driving signal and the second driving signal are output simultaneously, if the circuit board suspends outputting the first driving signal and the second driving signal, the first driving signal or the second driving signal is output separately. When the outputting of the first driving signal or the second driving signal is suspended, the first driving signal and the second driving signal are output simultaneously again, so that the brush head perform the alternating motion of the combined motion and the single motion. When the brush head cleans the teeth, the brush head not only applies peeling forces to remove the soft plaque and the dental plaque on the surfaces of the teeth in multiple directions, but also perform longitudinal or lateral cleaning of the teeth separately, thereby increasing the motion trajectory of the brush head and performing more comprehensive cleaning of the surfaces of the teeth.

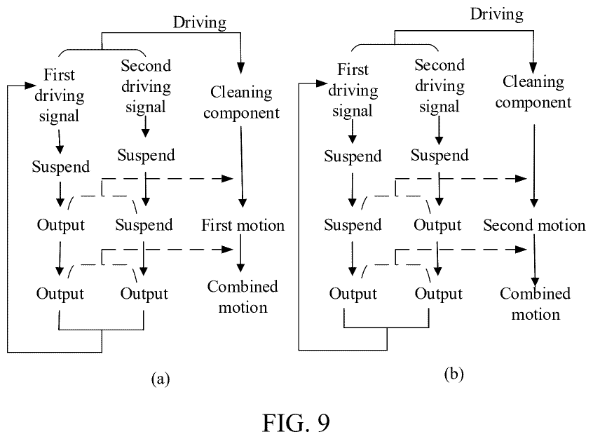

FIG. 9 is a schematic diagram of the system of the electric toothbrush according to another embodiment of the present disclosure.

As shown in (a) of FIG. 9, after simultaneously outputting the first driving signal and the second driving signal, when the circuit board suspends outputting the first driving signal and the second driving signal, the circuit board outputs the first driving signal separately. Then, after suspending outputting the first driving signal, the circuit board simultaneously outputs the first driving signal and the second driving signal again. Namely, the circuit board alternately outputs “first driving signal+second driving signal→first driving signal→first driving signal+second driving signal . . . ” to enable the brush head to perform the alternating motions of “combined motion→first motion→combined motion . . . ”, so that when the brush head is cleaning the teeth, the brush head not only simultaneously and multi-directionally applies the peeling forces to remove the soft plaque and the dental plaque on the surfaces of the teeth, but also performs longitudinal cleaning of the teeth separately to deeply clean the gaps between the teeth, thereby further improving the cleaning effect on the teeth.

Alternatively, as shown in (b) of FIG. 9, after simultaneously outputting the first driving signal and the second driving signal, when the circuit board suspends outputting the first driving signal and the second driving signal, the circuit board outputs the second driving signal separately. Then, after suspending outputting the second driving signal, the circuit board simultaneously outputs the first driving signal and the second driving signal again. Namely, the circuit board alternately outputs “first driving signal+second driving signal→second driving signal→first driving signal+second driving signal . . . ” to enable the brush head to perform the alternating motions of “combined motion→second motion→combined motion . . . ”, so that when the brush head is cleaning the teeth, the brush head not only simultaneously and multi-directionally applies the peeling forces to remove the soft plaque and the dental plaque on the surfaces of the teeth, but also performs lateral cleaning of the teeth separately to clean the gums and massage the gum line at the same time, which effectively prevent gum line recession.

Alternatively, after simultaneously outputting the first driving signal and the second driving signal, when the circuit board suspends outputting the first driving signal and the second driving signal, the circuit board alternately outputs the first driving signal and the second driving signal separately. Then, after suspending outputting the first driving signal or the second driving signal, the circuit board simultaneously outputs the first driving signal and the second driving signal again. Namely, the circuit board alternately outputs “first driving signal+second driving signal→first driving signal→first driving signal+second driving signal→second driving signal→first driving signal+second driving signal . . . ” to enable the brush head to perform the alternating motions of “combined motion→first motion→combined motion→second motion→combined motion . . . ”, so that when the brush head is cleaning the teeth, the brush head not only simultaneously and multi-directionally applies the peeling forces to remove the soft plaque and the dental plaque on the surfaces of the teeth, but also cleans the teeth longitudinally or laterally separately, which increases the cleaning effect of the brush head on the gaps between the teeth and massages the gum line during the cleaning process.

In one optional embodiment, the electric toothbrush further comprises a position sensor. The position sensor is connected to the circuit board. The position sensor is configured to detect a cleaning position of the brush head in the oral cavity and send the cleaning position to the circuit board. After receiving the cleaning position, the circuit board adjusts the first driving signal and/or the second driving signal corresponding to the cleaning position according to the cleaning position detected by the position sensor.

Optionally, the handle of the electric toothbrush may comprises the position sensor and the position sensor is interconnected to the circuit board for data transmission.

Optionally, the position sensor may comprise, but is not limited to an accelerometer and a gyroscope. A current position of the brush head in the oral cavity is detected by the accelerometer and the gyroscope. For example, the position sensor may detect that the current position of the brush head in the oral cavity is a side surface of the teeth, an occlusal surface of the teeth, or a tongue coating surface. The side surface of the teeth comprises all tooth surfaces on the teeth that are not the occlusal surface. For example, the side surface of the teeth is a buccal side surface, a lingual side surface, two surfaces facing each other of two adjacent teeth, a distal surface, and a mesial surface.

For instance, when the position sensor detects that the brush head is currently on the side surface or the occlusal surface of the teeth, position information is sent to the circuit board, and the circuit board adjusts at least one of the first driving signal and the second driving signal according to the position information, so that the cleaning method of the brush head is more in line with the cleaning requirements of different cleaning positions in the oral cavity, and the cleaning efficiency of the electric toothbrush for the oral cavity is improved.

Optionally, the circuit board outputs the first driving signal and the second driving signal only when the position information received by the circuit board is the current position is the tooth side or the occlusal surface of the teeth, thereby avoiding a problem that the user triggers the oral cleaning instruction when the brush head is not in contact with the side surface or the occlusal surface of the teeth. Therefore, cleaning products (for example, toothpaste) pasted on the brush head are not splashed due to movement of the brush head, thereby improving the user experience.

Exemplarily, according to the cleaning position detected by the position sensor, the circuit board adopts implementation methods for adjusting at least one of the first driving signal and the second driving signal according to the cleaning position, which are illustrated as follow.

### Implementation Method 1:

When the cleaning position detected by the position sensor is the side surface of the teeth, the circuit board is configured perform at least one of following four operations:
(1) adjusting a swing amplitude of the first motion to be greater than a movement amplitude of the second motion;
(2) adjusting a duty ratio of the first driving signal to be greater than a duty ratio of the second driving signal;
(3) adjusting a vibration frequency of the first motion to be greater than a vibration frequency of the second motion; and
(4) adjusting a driving frequency of the first driving signal to be greater than a driving frequency of the second driving signal.

Specifically, since an area of the side surface of the teeth that needs to be cleaned is relatively large, when the position sensor detects that the brush head is currently on the side surface of the teeth, the position information is sent to the circuit board, so that the circuit board adjusts the swing amplitude of the first motion of the brush head to be greater than the movement amplitude of the second motion according to the received position information; and/or, the circuit board adjusts the swing amplitude of the first motion and the movement amplitude of the second motion by adjusting the duty ratio of the first driving signal and the duty ratio of the second driving signal. That is, the duty ratio of the first driving signal is adjusted to be greater than the duty ratio of the second driving signal, thereby improving the cleaning ability of the brush head on the side surface of the teeth.

For example, when the position sensor detects that the brush head is currently on the side surface of the teeth, the circuit board adjusts the swing amplitude of the first motion of the brush head to be greater than the movement amplitude of the second motion. That is, a longitudinal swing amplitude of the brush head is greater than a lateral movement amplitude thereof, thereby increasing the longitudinal cleaning area of the brush head on the side surface of the teeth, reducing a missed area of the side surface brushed by the brush head, and cleaning the side surface of the teeth more comprehensively.

For another example, when the position sensor detects that the brush head is currently on the side surface of the teeth, the circuit board adjusts the duty ratio of the first driving signal to be greater than the duty ratio of the second driving signal, so as to adjust the swing amplitude of the first motion of the brush head to be greater than the movement amplitude of the second motion, thereby increasing the longitudinal cleaning area of the brush head on the side surface of the teeth, reducing the missed area of the side surface of the teeth brushed by the brush head, and cleaning the side surface of the teeth more comprehensively.

Exemplarily, since the area of the side surface of the teeth that needs to be cleaned is larger and have more soft plaque and dental plaque, when the position sensor detects that the brush head is currently on the side surface of the teeth, the position sensor sends the position information to the circuit board. The circuit board adjusts the vibration frequency of the first motion of the brush head to be greater than the vibration frequency of the second motion of the brush head according to the received position information; and/or, the circuit board adjusts the vibration frequency of the first motion and the vibration frequency of the second motion by adjusting the driving frequency of the first driving signal and the driving frequency of the second driving signal. That is, the driving frequency of the first driving signal is adjusted to be greater than the driving frequency of the second driving signal.

For example, when the position sensor detects that the brush head is currently on the side surface of the teeth, the circuit board adjusts the vibration frequency of the first motion of the brush head to be greater than the vibration frequency of the second motion of the brush head, so that the brush head applies a greater longitudinal peeling force to remove the soft plaque and the dental plaque on the side surface when cleaning the side surface of the teeth, thereby performing a deeper cleaning of the soft plaque and the dental plaque on the side surface of the teeth.

For another example, when the position sensor detects that the brush head is currently on the side surface of the teeth, the circuit board adjusts the driving frequency of the first driving signal to be greater than the driving frequency of the second driving signal, so as to adjust the vibration frequency of the first motion of the brush head to be greater than the vibration frequency of the second motion, so that the brush head applies a greater longitudinal peeling force to remove the soft plaque and the dental plaque on the side surface when cleaning the side surface of the teeth, thereby improving the cleaning effect of the brush head on the side surface of the teeth.

### Implementation Method 2:

When the cleaning position detected by the position sensor is the occlusal surface of the teeth, the circuit board is configured perform at least one of following four operations:
(1) adjusting the swing amplitude of the first motion to be less than the movement amplitude of the second motion;
(2) adjusting the duty ratio of the first driving signal to be less than the duty ratio of the second driving signal;
(3) adjusting the vibration frequency of the first motion to be less than the vibration frequency of the second motion; and
(4) adjusting the driving frequency of the first driving signal to be less than the driving frequency of the second driving signal.

Specifically, since an area of the occlusal surface of the teeth to be cleaned is small and narrow, in order to prevent the brush head from missing brushing when cleaning the occlusal surface of the teeth, when the position sensor detects that the brush head is currently on the occlusal surface of the teeth, the position sensor sends the position information to the circuit board. The circuit board adjusts the swing amplitude of the first motion of the brush head to be less than the movement amplitude of the second motion according to the received position information; and/or the circuit board adjusts the duty ratio of the first driving signal to be less than the duty ratio of the second driving signal, thereby improving the cleaning efficiency of the brush head on the occlusal surface of the teeth.

For example, when the position sensor detects that the brush head is currently on the occlusal surface of the teeth, the circuit board adjusts the swing amplitude of the first motion of the brush head to be less than the movement amplitude of the second motion. That is, the longitudinal swing amplitude of the brush head is less than the lateral movement amplitude, which avoids the problem that when the brush head swings too much in the longitudinal direction, only a small part of the area of the brush head contacts the occlusal surface of the teeth, thus avoiding low cleaning efficiency and improving the cleaning efficiency of the brush head on the occlusal surface of the teeth.

For another example, when the position sensor detects that the brush head is currently on the occlusal surface of the teeth, the circuit board adjusts the duty ratio of the first driving signal to be less than the duty ratio of the second driving signal, so as to adjust the swing amplitude of the first motion of the brush head to be less than the movement amplitude of the second motion, thereby avoiding the problem of low cleaning efficiency due to excessive longitudinal swing of the brush head and improving the cleaning efficiency of the brush head on the occlusal surface of the teeth.

For example, since the area of the occlusal surface of the teeth to be cleaned is small and narrow, there may be uneven areas, and there may be food residues that are difficult to clean in the uneven areas. When the position sensor detects that the brush head is currently on the occlusal surface of the teeth, the position sensor sends the position information to the circuit board. Then, the circuit board adjusts the vibration frequency of the first motion of the brush head to be less than the vibration frequency of the second motion according to the received position information; and/or the circuit board adjusts the driving frequency of the first driving signal to be less than the driving frequency of the second driving signal, so that the brush head applies a larger lateral peeling force to the food residues, thereby easily cleaning the food residues on the occlusal surface of the teeth.

For example, when the position sensor detects that the brush head is currently on the occlusal surface of the teeth, the circuit board adjusts the vibration frequency of the first motion of the brush head to be less than the vibration frequency of the second motion. That is, the vibration frequency of the second motion is greater than the vibration frequency of the first motion, so that the brush head applies a larger lateral peeling force when cleaning the occlusal surface, of the teeth. Therefore, the food residues on the occlusal surface of the teeth are easier to clean, thereby improving the cleaning efficiency of the brush head on the occlusal surface of the teeth.

For another example, when the position sensor detects that the brush head is currently on the occlusal surface of the teeth, the circuit board adjusts the driving frequency of the first driving signal to be less than the driving frequency of the second driving signal, so as to adjust the vibration frequency of the first motion of the brush head to be less than the vibration frequency of the second motion, thereby allowing the brush head to apply a larger lateral peeling force when cleaning the occlusal surface of the teeth. Therefore, it is easy to clean the food residues on the occlusal surface of the teeth, thereby improving the cleaning efficiency of the brush head on the occlusal surface of the teeth.

### Implementation Method 3:

According to the cleaning position detected by the position sensor, the circuit board is configured perform at least one of following two operations:
(1) adjusting the duty ratio of the first driving signal corresponding to the side surface of teeth to be greater than the duty ratio of the first driving signal corresponding to the occlusal surface of the teeth; and
(2) adjusting the driving frequency of the second driving signal corresponding to the side surface of the teeth to be less than a driving frequency of the second driving signal corresponding to the occlusal surface of the teeth.

For example, since the area to be cleaned on the side surface of the teeth is larger than the area to be cleaned on the occlusal surface of the teeth, the soft plaque and the dental plaque on the side surface of the teeth may be far more than the soft plaque and dental plaque on the occlusal surface of the teeth. In order to improve the cleaning efficiency of the brush head on the side surface of the teeth, the circuit board adjusts the duty ratio of the first driving signal corresponding to the side surface of the teeth to be greater than the duty ratio of the first driving signal corresponding to the occlusal surface of the teeth, so that the swing amplitude of the first motion corresponding to the side surface of the teeth is greater than the swing amplitude of the first motion corresponding to the occlusal surface of the teeth, so that the cleaning area of the brush head on the side surface of the teeth is greater than the cleaning area of the occlusal surface of the teeth. Therefore, more soft plaque and dental plaque are cleaned on the side surface of the teeth, which improves the cleaning efficiency of the brush head on the side surface of the teeth.

Further, the swing amplitude of the first motion is adjusted by adjusting the duty ratio of the first driving signal. That is, the duty ratio of the first driving signal corresponding to the side surface of the teeth is adjusted to be greater than the duty ratio of the first driving signal corresponding to the occlusal surface of the teeth. The circuit board correspondingly adjusts the swing amplitude of the first motion corresponding to the side surface of the teeth to be greater than the swing amplitude of the first motion corresponding to the occlusal surface of the teeth.

Alternatively, the circuit board may directly adjust the swing amplitude of the first motion corresponding to the side surface of the teeth to be greater than the swing amplitude of the first motion corresponding to the occlusal surface of the teeth.

Furthermore, since the brush head contact the gums over a large area when cleaning the side surface of the teeth, if a lateral vibration frequency of the brush head is too high, the gums may be damaged. In addition, when the brush head cleans the occlusal surface of the teeth, the brush head does not contact the gums nor damage the gums. Therefore, in order to protect the gums, the circuit board adjusts the driving frequency of the second driving signal corresponding to the side surface of the teeth to be less than the driving frequency of the second driving signal corresponding to the occlusal surface of the teeth, thereby avoiding the brush head from damaging the gums when cleaning the side surface of the teeth, so as to protect the gums.

Further, the vibration frequency of the second motion is adjusted by adjusting the driving frequency of the second driving signal. That is, the driving frequency of the second driving signal corresponding to the side surface of the teeth is less than the driving frequency of the second driving signal corresponding to the occlusal surface of the teeth. Therefore, the circuit board adjusts the vibration frequency of the second motion corresponding to the side surface of the teeth to be less than the vibration frequency of the second motion corresponding to the occlusal surface of the teeth.

Alternatively, the circuit board directly adjusts the vibration frequency of the second motion corresponding to the side surface of the teeth to be less than the vibration frequency of the second motion corresponding to the occlusal surface of the teeth.

Optionally, when the position sensor detects that the brush head is not in contact with the side surface and the occlusal surface of the teeth, the circuit board suspends the output of the first driving signal and the second driving signal.

Exemplarily, when the position sensor detects that the brush head is not currently in contact with the side surface and the occlusal surface of the teeth, the position sensor sends the position information to the circuit board to cause the circuit board to suspend the output of at least one of the first driving signal and the second driving signal, thereby preventing the brush head from moving when the brush head is not in contact with the side surface or the occlusal surface of the teeth. Namely, when the brush head is not currently in contact with the side surface or the occlusal surface of the teeth, the brush head is in a stationary state, which avoids energy loss of the electric toothbrush when the brush head is not cleaning the teeth, thereby improving the battery life of the electric toothbrush.

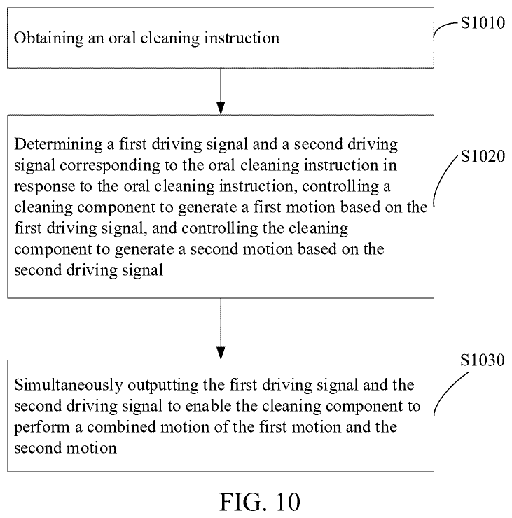

A control method of the electric toothbrush in the embodiments of the present disclosure is described in detail below with reference to FIGS. 10-13.

In conjunction with FIGS. 1-9, the control method of the electric toothbrush in the embodiments of the present disclosure is introduced. FIG. 10 is a flow chart of the control method of the electric toothbrush according to one embodiment of the present disclosure. The control method of the electric toothbrush is executed by the toothbrush 100 shown in FIG. 1 or the control unit 110 (i.e., the above-mentioned circuit board) shown in FIG. 1.

Specifically, as shown in FIG. 10, the control method 1000 comprises steps S1010-S1030.

The step S1010 comprises obtaining an oral cleaning instruction.

For instance, when the user needs to clean the oral cavity, the user is able to press the control button of the electric toothbrush to trigger the oral cleaning instruction. Alternatively, the user is able to send the oral cleaning instruction to the electric toothbrush through the smart terminal connected to the electric toothbrush, so that the control unit receives the oral cleaning instruction for oral cleaning.

The step S1020 comprises determining a first driving signal and a second driving signal corresponding to the oral cleaning instruction in response to the oral cleaning instruction, controlling a cleaning component to generate a first motion based on the first driving signal, and controlling the cleaning component to generate a second motion based on the second driving signal.

A motion direction of the first motion is different from a motion direction of the second motion. For instance, the first motion represents reciprocating swinging with a length extending direction of the cleaning component as an axis, and the second motion represents a reciprocating movement along the length extending direction of the cleaning component. Alternatively, the first motion represents reciprocating movement with the length extending direction of the cleaning component as the axis.

For instance, correspondences between oral cleaning parameters, the first driving signal and the second driving signal are pre-stored in the electric toothbrush, so that after receiving the oral cleaning instruction, the control unit responds to the oral cleaning instruction and queries the first driving signal and the second driving signal corresponding to the oral cleaning instruction from the correspondences according to the oral cleaning parameters carried by the oral cleaning instruction. Then, the control unit controls (also understood ad “drives”) the cleaning component (the brush head mentioned above) to generate reciprocating swings with the length extending direction of the cleaning component as the axis based on the first driving signal and controls the cleaning component to generate reciprocating movement along the length extending direction of the cleaning component based on the second driving signal.

Alternatively, the control unit responds to the oral cleaning instruction and queries the first driving signal and the second driving signal corresponding to the oral cleaning instruction from the correspondences according to the oral cleaning parameters carried by the oral cleaning instruction, the control unit controls the cleaning component to generate reciprocating movement with the length extending direction of the cleaning component as the axis based on the first driving signal and controls the cleaning component to generate reciprocating movement along the length extending direction of the cleaning component based on the second driving signal.

In one possible embodiment, the electric toothbrush comprises a multi-directional motor, for example, a bidirectional motor. In the step S1020, the step of controlling the cleaning component to generate the first motion based on the first driving signal and controlling the cleaning component to generate the second motion based on the second driving signal is realized by the bidirectional motor. Thar is, the step S1020 comprises controlling the bidirectional motor to drive the cleaning component to generate the first motion based on the first driving signal, and controlling the bidirectional motor to drive the cleaning component to generate the second motion based on the second driving signal.

As shown in (a) of FIG. 5, when the control unit receives the oral cleaning instruction triggered by the user, the control unit outputs the first driving signal to the bidirectional motor to drive the bidirectional motor to drive the brush head to generate the first motion (as shown in (a) in FIG. 5). When the bidirectional motor drives the cleaning component to generate the first motion, the cleaning component applies a longitudinal peeling force to the soft plaque or the dental plaque on the surfaces of the teeth, thereby longitudinally removing the soft plaque or the dental plaque on the surfaces of the teeth.

As shown in (b) of FIG. 5, when the control unit receives the oral cleaning instruction triggered by the user, the control unit outputs the second driving signal to the bidirectional motor to drive the bidirectional motor to drive the cleaning component to generate the second motion (as shown in (b) in FIG. 5). When the bidirectional motor drives the cleaning component to generate the second motion, the brush head applies a horizontal peeling force to the soft plaque or the dental plaque on the surfaces of the teeth, thereby laterally removing the soft plaque or the dental plaque on the surfaces of the teeth.

The step S1030 comprises simultaneously outputting the first driving signal and the second driving signal to enable the cleaning component to performs a combined motion of the first motion and the second motion.

Specifically, after the control unit determines the first driving signal and second driving signal in response to the oral cleaning instruction, the control unit outputs the first driving signal and the second driving signal at the same time, the cleaning component generates the combined motion of the first motion driven by the first driving signal and the second motion driven by the second driving signal (as shown in (a) in FIG. 4, or as shown in (b) in FIG. 4). That is, the cleaning component performs an arc motion to clean the oral cavity.

Furthermore, since the output time of the first driving signal and the output time of the second driving signal, as well as the vibration frequency of the first motion and the vibration frequency of the second motion of the cleaning component affect a projection of the cleaning component on the teeth when the cleaning component performs the arc motion on the teeth. When the cleaning component performs the arc motion on the teeth, a shape of a curve of the projection of the cleaning component on the teeth may comprise but is not limited to the shapes shown in FIG. 6, which are not repeatedly illustrated herein.

As shown in (c) of FIG. 5, when the control unit receives the oral cleaning instruction triggered by the user, the control unit simultaneously outputs the first driving signal and the second driving signal to the bidirectional motor, so that the bidirectional motor simultaneously drives the cleaning component to generate the first motion and the second motion that have different motion directions, so that the cleaning component performs the combined motion of high-frequency vibration. When the teeth are scraped in all directions under the high-frequency vibration, the soft plaque and the dental plaque on the teeth are easier to clean, thereby improving a cleaning power of the cleaning component. In addition, when the cleaning component cleans the teeth through the arc motion, the cleaning component smoothly scrapes the surfaces of the teeth or positions where the teeth meet the gums, thereby avoiding damage to the gums due to straight scraping while massaging the gums to avoid gum atrophy.

In the control method 1000 shown in FIG. 10, two driving signals are simultaneously output to drive the cleaning component to output two motions in different directions (i.e., the first motion and the second motion), thereby realizing the combined motion of the cleaning component in two different directions. The combined motion is the arc motion generated by signal transmission, which avoids a problem of poor oral cleaning effect caused by the cleaning component performing a single motion to clean the oral cavity, and is not limited by the mechanical transmission to the motion frequency of the cleaning component, thereby avoiding a problem of low cleaning force caused by the motion of the cleaning component under mechanical transmission. Therefore, the cleaning component apply the multi-directional peeling force to the soft plaque or dental plaque on the surfaces of the teeth under high-frequency vibration, so that the soft plaque or the dental plaque on the surfaces of the teeth is easier to clean, thereby improving the cleaning ability of the electric toothbrush on the teeth.

Further, since the combined motion of the first motion and the second motion performed by the cleaning component is the arc motion, damage to the gums due to straight scraping of the single motion is avoided. Therefore, when the cleaning component cleans the teeth through the arc motion, the cleaning component smoothly scrapes the surfaces of the teeth or positions where the teeth meet the gums, thereby avoiding damage to the gums due to straight scraping while massaging the gums to avoid gum atrophy.

Furthermore, since the vibration frequency of the cleaning component in different directions may affect the cleaning effect on the teeth, the vibration frequency of the first motion and the vibration frequency of the second motion are set. In addition, in addition to the vibration frequency of the cleaning component in different directions affecting the cleaning effect on the teeth, the swing amplitude of the cleaning component in different directions also affects the cleaning effect on the teeth. Therefore, the swing amplitude of the first motion and the movement amplitude of the second motion are set.

It should be noted that specific implementation methods of setting the vibration frequency of the first motion and the vibration frequency of the second motion, and setting the swing amplitude of the first motion and the movement amplitude of the second motion may refer to the detailed description of FIGS. 3-9 illustrated above, which are not repeated herein.

Optionally, the step S1030 of simultaneously outputting the first driving signal and the second driving signal to enable the cleaning component to performs the combined motion of the first motion and the second motion comprises a step of after outputting the first driving signal for a first duration, simultaneously outputting the first driving signal and the second driving signal.

It should be noted that, after the first driving signal is output for the first duration, the specific implementation of simultaneously outputting the first driving signal and the second driving signal may refer to the detailed description of FIG. 8 illustrated above, which is not repeated herein.

Optionally, in addition to controlling the cleaning component to perform the combined motion of the first motion and the second motion, the control unit is further configured to control the cleaning component to perform an alternating motion of a single motion and the combined motion.

It should be noted that the specific implementation of the control unit controlling the cleaning component to perform the alternating movement of the single motion and the combined motion can refer to the detailed description of FIG. 9 above, which will not be repeated here.

Specifically, when the position sensor of the electric toothbrush detects that the cleaning component is currently on the side surface or the occlusal surface of the teeth, the position sensor sends the position information to the control unit, so that the control unit adjusts at least one of the first driving signal and the second driving signal according to the received position information.

Specifically, the control unit outputs the first driving signal and the second driving signal only when the received position information indicates that the cleaning component is currently on the side surface or the occlusal surface of the teeth, thereby avoiding triggering the oral cleaning instruction when the cleaning component is not in contact with the side surface or the occlusal surface of the teeth. Therefore, the cleaning product (for example, toothpaste) pasted on the cleaning component is not caused to splash, thereby improving the user experience.

Specifically, the control unit adjusts at least one of the first driving signal and the second driving signal corresponding to the cleaning position according to the cleaning position detected by the position sensor, which may comprise the above-mentioned implementation method 1, implementation method 2, and implementation method 3.

It should be noted that specific implementation methods of implementation method 1, implementation method 2, and implementation method 3 may refer to the detailed description related to FIGS. 3-9, which are not repeated herein.

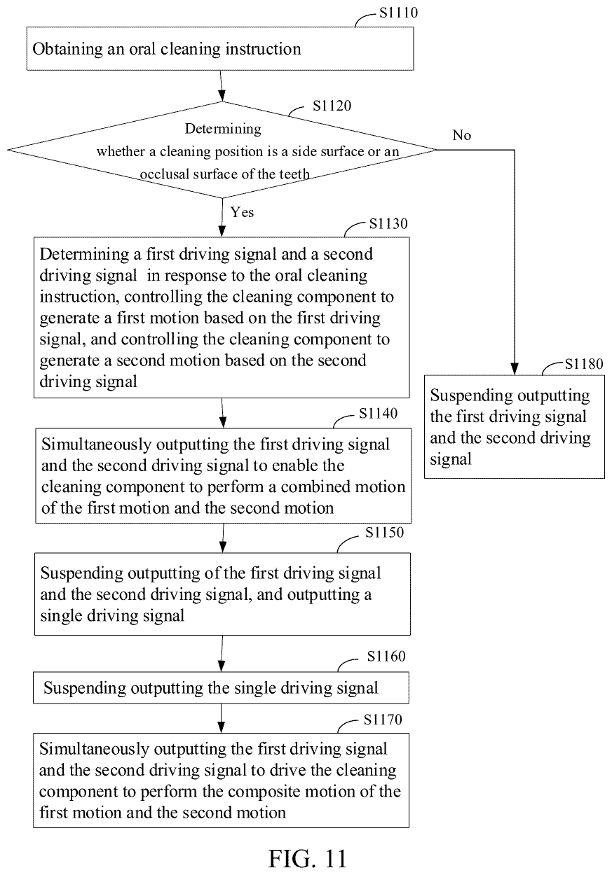

FIG. 11 is a flow chart of the control method of the electric toothbrush according to another embodiment of the present disclosure.

As shown in FIG. 11, the control method 1100 comprises steps S1110-S1180.

The step S110 comprises obtaining an oral cleaning instruction.

For instance, when the user needs to clean the oral cavity, the user is able to press the control button of the electric toothbrush to trigger the oral cleaning instruction, so that the control unit receives the oral cleaning instruction for oral cleaning.

The step S1120 comprises determining whether a cleaning position is a side surface or an occlusal surface of the teeth; if yes, executing the step S1130; and if not, executing the step S1180.

For instance, after detecting the oral cleaning instruction for oral cleaning, the control unit controls the position sensor to detect the current position of the cleaning component in the oral cavity and determines whether the cleaning position is the side surface or the occlusal surface of the teeth according to the position information detected by the position sensor.

The step S1130 comprises determining a first driving signal and a second driving signal corresponding to the oral cleaning instruction in response to the oral cleaning instruction, controlling the cleaning component to generate a first motion based on the first driving signal, and controlling the cleaning component to generate a second motion based on the second driving signal.

For instance, correspondences between oral cleaning parameters, the first driving signal and the second driving signal are pre-stored in the electric toothbrush, so that after determining that the cleaning position is the side surface or the occlusal surface of the teeth, the control unit responds to the oral cleaning instruction and queries the first driving signal and the second driving signal corresponding to the oral cleaning instruction from the correspondences according to the oral cleaning parameters carried by the oral cleaning instruction. Then, the control unit controls the cleaning component to generate reciprocating swings with the length extending direction of the cleaning component as the axis based on the first driving signal and controls the cleaning component to generate reciprocating movement along the length extending direction of the cleaning component based on the second driving signal.

Alternatively, the control unit responds to the oral cleaning instruction and queries the first driving signal and the second driving signal corresponding to the oral cleaning instruction from the correspondences according to the oral cleaning parameters carried by the oral cleaning instruction, the control unit controls the cleaning component to generate reciprocating movement with the length extending direction of the cleaning component as the axis based on the first driving signal and controls the cleaning component to generate reciprocating movement along the length extending direction of the cleaning component based on the second driving signal.

The step S1140 comprises simultaneously outputting the first driving signal and the second driving signal to enable the cleaning component to perform a combined motion of the first motion and the second motion.

Specifically, after the control unit determines the first driving signal and second driving signal in response to the oral cleaning instruction, the control unit outputs the first driving signal and the second driving signal at the same time, so that the cleaning component generates the combined motion of the first motion driven by the first driving signal and the second motion driven by the second driving signal to clean the oral cavity.

It should be noted that the specific implementation of the step S1140 is introduced in detail in the step S1030, which is not repeated herein.

The step S1150 comprises suspending outputting of the first driving signal and the second driving signal, and outputting a single driving signal.

For instance, after the first driving signal and the second driving signal are output at the same time, when the output of the first driving signal and the second driving signal is suspended, the control unit outputs the single driving signal. That is, the control unit separately outputs the first driving signal or the second driving signal.

The step S1160 comprises suspending outputting the single driving signal.

For instance, after the first driving signal or the second driving signal is outputted separately, if the output of the single driving signal is suspended, the step S1170 is executed.

The step S1170 comprises simultaneously outputting the first driving signal and the second driving signal to drive the cleaning component to perform the composite motion of the first motion and the second motion.

For instance, when the first driving signal and the second driving signal are simultaneously output, and when the control unit suspends outputting the first driving signal and the second driving signal, the control unit outputs the first driving signal or the second driving signal. When the first driving signal or the second driving signal is suspended, the first driving signal and the second driving signal are output again.

The step S1180 comprises suspending outputting the first driving signal and the second driving signal.

For instance, in the step S1120, if it is detected that the cleaning position is not the side surface or the occlusal surface of the teeth, the first driving signal and the second driving signal are suspended to avoid movement of the cleaning component when the cleaning component is not in contact with the side surface or the occlusal surface of the teeth. That is, when the cleaning component is not currently in contact with the side surface or the occlusal surface of the teeth, the cleaning component is controlled to be in a stop state, thereby avoiding the energy loss of the electric toothbrush when the cleaning component is not cleaning the teeth, thereby improving the endurance of the electric toothbrush.

It should be noted that the embodiments corresponding to all the steps in FIG. 11 are introduced in FIGS. 3-10, which are not repeated herein.

It should be understood that the above examples are intended to help those skilled in the art understand the embodiments of the present disclosure, rather than to limit the embodiments of the present disclosure to the specific numerical values or specific scenarios illustrated. Based on the above examples, those skilled in the art can obviously make various equivalent modifications or changes, and such modifications or changes should fall within the scope of the embodiments of the present disclosure.

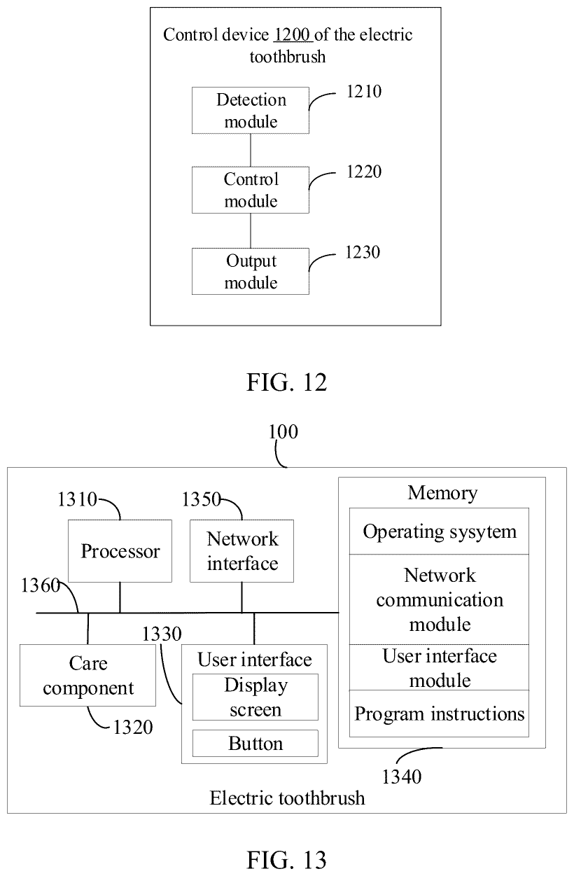

The control method of the electric toothbrush provided in the embodiments of the present disclosure is described in detail above in conjunction with FIGS. 1-11; and embodiments of the electric toothbrush of the present disclosure are described in detail below in conjunction with FIGS. 12-13. It should be understood that the electric toothbrush in the embodiments of the present disclosure is able to execute the various methods of the aforementioned embodiments of the present disclosure. That is, a specific working processes of the following various products may refer to the corresponding processes in the aforementioned embodiments of the control method.

FIG. 12 is a flow chart of a control device of the electric toothbrush according to one embodiment of the present disclosure. For instance, as shown in FIG. 12, the control device 1200 comprises a detection module 1210, a control module 1220, and an output module 1230,

The detection module 1210 is configured to obtain an oral cleaning instruction.

The control module 1220 is configured to determine a first driving signal and a second driving signal corresponding to the oral cleaning instruction in response to the oral cleaning instruction, control a cleaning component to generate a first motion based on the first driving signal, and control the cleaning component to generate a second motion based on the second driving signal. A motion direction of the first motion is different from a motion direction of the second motion.

The output module 1230 is configured to simultaneously output the first driving signal and the second driving signal to enable the cleaning component to performs a combined motion of the first motion and the second motion.

In one optional embodiment, the first motion comprises reciprocating swinging with a length extending direction of the cleaning component as an axis, and the second motion comprises a reciprocating movement along the length extending direction of the cleaning component.

In one optional embodiment, the first motion further comprise reciprocating movement with the length extending direction of the brush head 120 as the axis.

In one optional embodiment, a vibration frequency of the first motion is equal to a vibration frequency of the second motion, and/or a driving frequency of the first driving signal is equal to a driving frequency of the second driving signal.

In one optional embodiment, a wing amplitude of the first motion is not greater than a motion amplitude of the second motion, and/or a duty ratio of the first driving signal is not greater than a duty ratio of the second driving signal.

In one optional embodiment, the output module 1230 is configured to simultaneously output the first driving signal and the second driving signal after outputting the first driving signal for a first duration. The first duration is a sum of N period duration and a quarter of a period duration, or the predetermined time difference is a sum of the N period duration and three quarters of the period duration. N is an integer not less than 0, and the period duration is a single complete output duration of the first driving signal or a single complete output duration of the second driving signal.

In one optional embodiment, the output module is configured to suspend outputting the first driving signal and the second driving signal and output a single driving signal. The single driving signal is the first driving signal or the second driving signal. Further, the output module is configured to suspend outputting the single driving signal and simultaneously output the first driving signal and the second driving signal again.

In one optional embodiment, a vibration frequency of the first motion is greater than the vibration frequency of the second motion, and/or a driving frequency of the first driving signal is greater than a driving frequency of the second driving signal.

In one optional embodiment, the vibration frequency of the first motion is not less than twice the vibration frequency of the second motion.

In one optional embodiment, the electric toothbrush comprises a position sensor configured to detect a cleaning position of the cleaning component in an oral cavity. When it is detected that the cleaning position is a side surface of teeth, the control module 1220 adjusts the swing amplitude of the first motion to be greater than the motion amplitude of the second motion. When it is detected that the cleaning position is the side surface of the teeth, the control module 1220 adjusts the duty ratio of the first driving signal to be greater than the duty ratio of the second driving signal. When it is detected that the cleaning position is the side surface of the teeth, the control module 1220 adjusts the vibration frequency of the first motion to be greater than the vibration frequency of the second motion. When it is detected that the cleaning position is the side surface of the teeth, the control module 1220 adjusts the driving frequency of the first driving signal to be greater than the driving frequency of the second driving signal.

In one optional embodiment, when it is detected that the cleaning position is the occlusal surface of the teeth, the control module 1220 adjusts the swing amplitude of the first motion to be less than the motion amplitude of the second motion. When it is detected that the cleaning position is the occlusal surface of the teeth, the control module 1220 adjusts the duty ratio of the first driving signal to be less than the duty ratio of the second driving signal. When it is detected that the cleaning position is the occlusal surface of the teeth, the control module 1220 adjusts the vibration frequency of the first motion to be less than the vibration frequency of the second motion. When it is detected that the cleaning position is the occlusal surface of the teeth, the control module 1220 adjusts the driving frequency of the first driving signal to be less than the driving frequency of the second driving signal.

In one optional embodiment, the cleaning positions comprises the side surface of the teeth. The control module 1220 is configured to adjust the duty ratio of the first driving signal corresponding to the side surface of teeth to be greater than the duty ratio of the first driving signal corresponding to the occlusal surface of the teeth. The control module 1220 is configured to adjust the driving frequency of the second driving signal corresponding to the side surface of the teeth to be less than the driving frequency of the second driving signal corresponding to the occlusal surface of the teeth.

In one optional embodiment, the electric toothbrush further comprises a bidirectional motor. The control module 1220 is configured to control the bidirectional motor to drive the cleaning component to generate the first motion based on the first driving signal and control the bidirectional motor to drive the cleaning component to generate the second motion based on the second driving signal.

It should be noted that the control device 1210 is embodied in a form of functional modules. The term “module” may be implemented in the form of software and/or hardware, and is not specifically limited thereto.

For example, a “module” may be a software program, a hardware circuit, or a combination thereof. The hardware circuit may comprise an application-specific integrated circuit (ASIC), an electronic circuit, a processor for executing one or more software or firmware programs (such as a shared processor, a dedicated processor, or a group processor, etc.), a memory, a merged logic circuit, and/or other suitable components that support the described functions.

Therefore, the modules of examples described in the embodiments of the present disclosure can be implemented in electronic hardware, or a combination of computer software and electronic hardware. Whether these functions are performed in hardware or software depends on the specific application and design constraints of the technical solution. Those skilled in the art can use different methods to implement the described functions for a specific application, and such implementation should fall within the scope of the present disclosure.

FIG. 13 is a structural schematic diagram of the electric toothbrush according to one embodiment of the present disclosure.

As shown in FIG. 13, the electric toothbrush 100 comprises at least one processor 1310, a cleaning component 1320, a user interface 1330, a memory 1340, at least one network interface 1350, and at least one communication bus 1360.

The electric toothbrush 900 may be, but is not limited to, the oral cleaning device.

The at least one communication bus 1360 is configured to realize connection and communication between the various components of the electric toothbrush 100.

The cleaning component 1320 is configured to care for the oral cavity of the user.

The user interface 1330 comprises a display screen and a camera. Optionally, the user interface 1330 may further comprises a standard wired interface and a wireless interface.

Optionally, the at least one network interface 1350 comprises a BLUETOOTH module, a near field communication (NFC) module, a wireless fidelity (Wi-Fi) module, etc.

The at least one processor 1310 comprises one or more processing cores. The at least one processor 1310 uses various interfaces and lines to connect various parts of the electric toothbrush 100. The at least one processor 1310 executes various functions and processes data of the electric toothbrush 100 by running or executing instructions, programs, code sets or instruction sets stored in the memory 1340, and calling data stored in the memory 1340. Optionally, the at least one processor 1310 is implemented by at least one hardware of a digital signal processing (DSP), a field programmable gate array (FPGA), and a programmable logic array (PLA). The at least one processor 1310 may integrate one or a combination of a central processing unit (CPU), a graphics processing unit (GPU), and a modem. The CPU mainly processes an operating system and an application for the electric toothbrush 100. The GPU is responsible for rendering and drawing content to be displayed on the display screen. The modem is configured to process wireless communications. It is understood that the modem may not be integrated into the at least one processor 1310, but implemented by a chip.

The memory 1340 may be a random access memory (RAM) or a read-only memory (ROM). Optionally, the memory 1340 may be a non-transitory computer-readable medium. The memory 1340 is configured to store the instructions, the programs, the codes, the code sets or the instruction sets. The memory 1340 comprises a program storage area and a data storage area. The program storage area stores the instructions for implementing the operating system, the instructions for at least one function (such as a receiving function, a control function, a determination function, etc.), the instructions for implementing the controls method of the present disclosure, etc. The data storage area stores data involved in the control method of the present disclosure, etc. Optionally, the memory 1340 may be at least one storage device located away from the at least one processor 1310. As shown in FIG. 13, the memory 1340 served as a computer storage medium may comprises the operating system, a network communication module, a user interface module, and program instructions.

In one optional embodiment, in the electric toothbrush shown in FIG. 13, the at least one processor 1310 is configured to call the program instructions stored in the memory 1340. Further, the at least one processor 1310 is configured to: obtain an oral care instruction, determine a first driving signal and a second driving signal corresponding to the oral cleaning instruction in response to the oral cleaning instruction, control a cleaning component to generate a first motion based on the first driving signal, control the cleaning component to generate a second motion based on the second driving signal, and simultaneously output the first driving signal and the second driving signal to enable the cleaning component to performs a combined motion of the first motion and the second motion. A motion direction of the first motion is different from a motion direction of the second motion.

In one optional embodiment, the first motion comprises reciprocating swinging with a length extending direction of the cleaning component as an axis, and the second motion comprises a reciprocating movement along the length extending direction of the cleaning component.

In one optional embodiment, the first motion further comprise reciprocating movement with the length extending direction of the brush head 120 as the axis.

In one optional embodiment, a vibration frequency of the first motion is equal to a vibration frequency of the second motion, and/or a driving frequency of the first driving signal is equal to a driving frequency of the second driving signal.

In one optional embodiment, a wing amplitude of the first motion is not greater than a motion amplitude of the second motion, and/or a duty ratio of the first driving signal is not greater than a duty ratio of the second driving signal.

In one optional embodiment, when the at least one processor 1310 simultaneously outputs the first driving signal and the second driving signal, the at least one processor 1130 is configured to simultaneously output the first driving signal and the second driving signal after outputting the first driving signal for a first duration. The first duration is a sum of N period duration and a quarter of a period duration, or the predetermined time difference is a sum of the N period duration and three quarters of the period duration. N is an integer not less than 0, and the period duration is a single complete output duration of the first driving signal or a single complete output duration of the second driving signal.

In one optional embodiment, the at least one processor 1310 is configured to suspend outputting the first driving signal and the second driving signal and output a single driving signal. The single driving signal is the first driving signal or the second driving signal. Further, the at least one processor 1310 is configured to suspend outputting the single driving signal and simultaneously output the first driving signal and the second driving signal again.

In one optional embodiment, a vibration frequency of the first motion is greater than the vibration frequency of the second motion, and/or a driving frequency of the first driving signal is greater than a driving frequency of the second driving signal.

In one optional embodiment, the vibration frequency of the first motion is not less than twice the vibration frequency of the second motion.

In one optional embodiment, the electric toothbrush comprises a position sensor configured to detect a cleaning position of the cleaning component in an oral cavity. When simultaneously outputting the first driving signal and the second driving signal, the at least one process 1310 is configured to adjust at least one of the first driving signal and the second driving signal corresponding to the cleaning position according to the cleaning position detected by the position sensor.

In one optional embodiment, if it is detected that the cleaning component is not in contact with the surface to be cleaned, the at least one processor 1310 is further configured to suspend outputting the first driving signal and the second driving signal.

In one optional embodiment, the cleaning positions comprises a side surface of the teeth. When adjusting the at least one of the first driving signal and the second driving signal corresponding to the cleaning position according to the cleaning position detected by the position sensor, the at least one processor 1310 is further configured to execute at least one of following steps. When it is detected that the cleaning position is the side surface of teeth, the at least one processor 1310 adjusts the swing amplitude of the first motion to be greater than the motion amplitude of the second motion. When it is detected that the cleaning position is the side surface of teeth, the at least one processor 1310 adjusts the duty ratio of the first driving signal to be greater than the duty ratio of the second driving signal. When it is detected that the cleaning position is the side surface of teeth, the at least one processor 1310 adjusts the vibration frequency of the first motion to be greater than the vibration frequency of the second motion. When it is detected that the cleaning position is the side surface of teeth, the at least one processor 1310 adjusts the driving frequency of the first driving signal to be greater than the driving frequency of the second driving signal.

In one optional embodiment, when adjusting the at least one of the first driving signal and the second driving signal corresponding to the cleaning position according to the cleaning position detected by the position sensor, the at least one processor 1310 is further configured to execute at least one of following steps. When it is detected that the cleaning position is the occlusal surface of the teeth, the at least one processor 1310 adjusts the swing amplitude of the first motion to be less than the motion amplitude of the second motion. When it is detected that the cleaning position is the occlusal surface of the teeth, the at least one processor 1310 adjusts the duty ratio of the first driving signal to be less than the duty ratio of the second driving signal. When it is detected that the cleaning position is the occlusal surface of the teeth, the at least one processor 1310 adjusts the vibration frequency of the first motion to be less than the vibration frequency of the second motion. When it is detected that the cleaning position is the occlusal surface of the teeth, the at least one processor 1310 adjusts the driving frequency of the first driving signal to be less than the driving frequency of the second driving signal.

In one optional embodiment, the cleaning positions comprises the side surface of the teeth and the occlusal surface of the teeth. When adjusting the at least one of the first driving signal and the second driving signal corresponding to the cleaning position according to the cleaning position detected by the position sensor, the at least one processor 1310 is configured to adjust the duty ratio of the first driving signal corresponding to the side surface of teeth to be greater than the duty ratio of the first driving signal corresponding to the occlusal surface of the teeth, and/or the at least one processor 1310 is configured to adjust the driving frequency of the second driving signal corresponding to the side surface of the teeth to be less than the driving frequency of the second driving signal corresponding to the occlusal surface of the teeth.

In one optional embodiment, the electric toothbrush further comprises a bidirectional motor. When controlling the cleaning component to generate the first motion based on the first driving signal and controlling the cleaning component to generate the second motion based on the second driving signal, the at least one processor 1310 is configured to control the bidirectional motor to drive the cleaning component to generate the first motion based on the first driving signal and control the bidirectional motor to drive the cleaning component to generate the second motion based on the second driving signal.

The embodiments of the present disclosure further provides a computer storage medium, and the instructions are stored in the computer storage medium. When the instructions are executed on a computer or the at least one processor, the computer or the at least one processor executes one or more steps of the control method in any of the embodiments. When component modules of the control device of the electric toothbrush are implemented in a form of software functional units and are sold or used as an independent product, the component modules are stored in the computer storage medium.

In the above embodiments, the present disclosure may be implemented in whole or in part by software, hardware, firmware or any combination thereof. When implemented by software, the software is implemented in whole or in part of a form of a computer program product. The computer program product comprises one or more computer instructions. When the one or more computer program instructions are loaded and executed on the computer, the process or function described in the embodiments of the present disclosure is generated in whole or in part. The computer may be a general-purpose computer, a special-purpose computer, a computer network, or other programmable device. The one or more computer instructions may be stored in the computer-readable storage medium or transmitted through the computer-readable storage medium. The one or more computer instructions may be transmitted from a website site, a computer, a server, or a data center to another website site, another computer, another server or another data center by wired (e.g., coaxial cable, optical fiber, digital subscriber line) or wireless (e.g., infrared, wireless, microwave, etc.) mode. The computer-readable storage medium may be any available medium that is able to be accessed by the computer or a data storage device such as the server or the data center that comprises one or more available media integrated. The one or more available media may be a magnetic medium (e.g., a floppy disk, a hard disk, a magnetic tape), an optical medium (e.g., a digital versatile disc (DVD)), or a semiconductor medium (e.g., a solid state disk (SSD)).

Those skilled in the art can understand that all or part of the processes in the above-mentioned embodiments can be implemented by instructing the relevant hardware through the computer programs, and the computer programs may be stored in the computer-readable storage medium. When the computer programs are executed, the processes of the embodiments of the present disclosure are executed. The storage medium comprises the ROM, the RAM, a magnetic disk, an optical disk, or other media that are able to store the program codes. In the absence of conflict, the technical features in the embodiments and implementation schemes of the present disclosure can be combined arbitrarily.

The above are only optional embodiments of the present disclosure, but the protection scope of the present disclosure is not limited thereto. Any changes or substitutions that can be easily conceived by those skilled in the art within the technical scope disclosed in the present disclosure shall be fall in the protection scope of the present disclosure. Therefore, the protection scope of the present disclosure should be determined by the protection scope of the claims.

What is claimed is:

1. An electric toothbrush, comprising a handle, a circuit board, a bidirectional motor, and a brush head;
wherein the circuit board is connected to the bidirectional motor, the circuit board and the bidirectional motor are disposed in the handle, and the bidirectional motor is connected to the brush head;
wherein the circuit board is configured to output a first driving signal and a second driving signal;
wherein the bidirectional motor is configured to drive the brush head to generate a first motion relative to the handle based on the first driving signal and is configured to drive the brush head to generate a second motion relative to the handle based on the second driving signal; and
wherein a motion direction of the first motion is different from a motion direction of the second motion;
wherein the circuit board simultaneously outputs the first driving signal and the second driving signal, so that the brush head performs a combined motion of the first motion and the second motion.

2. The electric toothbrush according to claim 1, wherein the bidirectional motor comprises a first driving mechanism and a second driving mechanism;
wherein the first driving mechanism and the second driving mechanism are connected to the brush head, and the first driving mechanism and the second driving mechanism are disposed along an extending direction of the handle;
wherein the first driving mechanism is configured to drive the brush head to generate the first motion based on the first driving signal, and the second driving mechanism is configured to drive the brush head to generate the second motion based on the second driving signal.

3. The electric toothbrush according to claim 2, wherein the first driving mechanism is configured to drive, based on the first driving signal, the brush head to swing in a reciprocating manner with a length extending direction of the brush head as an axis;
wherein the second driving mechanism is configured to drive the brush head to reciprocate in the length extending direction of the brush head based on the second driving signal.

4. The electric toothbrush according to claim 2, wherein the bidirectional motor further comprises a first output shaft and a second output shaft, the first output shaft is different from the second output shaft, the first output shaft is connected to the first driving mechanism, the second output shaft is connected to the second driving mechanism, and the first output shaft and the second output shaft are connected to the brush head;
wherein the first output shaft is configured to drive the brush head to perform the first motion based on the first driving signal, and the second output shaft is configured to drive the brush head to perform the second motion based on the second driving signal.

5. The electric toothbrush according to claim 2, wherein the bidirectional motor further comprises a third output shaft, the third output shaft is connected to the first driving mechanism and the second driving mechanism, and the third output shaft is connected to the brush head;
wherein the third output shaft is configured to drive the brush head to perform the first motion based on the first driving signal and is configured to drive the brush head to perform the second motion based on the second driving signal.

6. The electric toothbrush according to claim 1, wherein a vibration frequency of the first motion is equal to a vibration frequency of the second motion; and/or
a driving frequency of the first driving signal is equal to a driving frequency of the second driving signal.

7. The electric toothbrush according to claim 6, wherein a wing amplitude of the first motion is not greater than a movement amplitude of the second motion; and/or
a duty ratio of the first driving signal is not greater than a duty ratio of the second driving signal.

8. The electric toothbrush according to claim 6, wherein a predetermined time difference is defined between an output time of the first driving signal and an output time of the second driving signal; and
the predetermined time difference is a sum of N period duration and a quarter of a period duration, or the predetermined time difference is a sum of the N period duration and three quarters of the period duration; the period duration is a single complete output duration of the first driving signal or a single complete output duration of the second driving signal; and N is an integer not less than 0.

9. The electric toothbrush according to claim 1, wherein the circuit board is further configured to
suspend outputting the first driving signal and the second driving signal, and output a single driving signal, wherein the single driving signal is the first driving signal or the second driving signal; and
suspend outputting the single driving signal, and simultaneously output the first driving signal and the second driving signal again.

10. The electric toothbrush according to claim 1, wherein a vibration frequency of the first motion is greater than the vibration frequency of the second motion; and/or
a driving frequency of the first driving signal is greater than a driving frequency of the second driving signal.

11. A control method of an electric toothbrush, comprising steps:
obtaining an oral cleaning instruction;
determining a first driving signal and a second driving signal corresponding to the oral cleaning instruction in response to the oral cleaning instruction, controlling a cleaning component to generate a first motion based on the first driving signal, and controlling the cleaning component to generate a second motion based on the second driving signal, wherein a motion direction of the first motion is different from a motion direction of the second motion; and
simultaneously outputting the first driving signal and the second driving signal to enable the cleaning component to performs a combined motion of the first motion and the second motion.

12. The control method according to claim 11, wherein the first motion comprises reciprocating swing with a length extending direction of the cleaning component as an axis, and the second motion comprises a reciprocating movement along the length extending direction of the cleaning component.

13. The control method according to claim 12, wherein a vibration frequency of the first motion is equal to a vibration frequency of the second motion; and/or
a driving frequency of the first driving signal is equal to a driving frequency of the second driving signal.

14. The control method according to claim 13 wherein a wing amplitude of the first motion is not greater than a movement amplitude of the second motion; and/or
a duty ratio of the first driving signal is not greater than a duty ratio of the second driving signal.

15. The control method according to claim 13, wherein the step of simultaneously outputting the first driving signal and the second driving signal to enable the cleaning component to performs the combined motion of the first motion and the second motion comprises:
after outputting the first driving signal for a first duration, simultaneously outputting the first driving signal and the second driving signal;
wherein the first duration is a sum of N period duration and a quarter of a period duration, or the predetermined time difference is a sum of the N period duration and three quarters of the period duration; N is an integer not less than 0, and the period duration is a single complete output duration of the first driving signal or a single complete output duration of the second driving signal.

16. The control method according to claim 11, wherein the control method further comprises:
suspending outputting the first driving signal and the second driving signal, and output a single driving signal, wherein the single driving signal is the first driving signal or the second driving signal; and
suspending outputting the single driving signal, and simultaneously outputting the first driving signal and the second driving signal again.

17. The control method according to claim 12, wherein a vibration frequency of the first motion is greater than the vibration frequency of the second motion; and/or
a driving frequency of the first driving signal is greater than a driving frequency of the second driving signal.

18. The control method according to claim 12, wherein the electric toothbrush comprises a position sensor configured to detect a cleaning position of the cleaning component in an oral cavity, and the step of simultaneously outputting the first driving signal and the second driving signal comprises:
adjusting at least one of the first driving signal and the second driving signal corresponding to the cleaning position according to the cleaning position detected by the position sensor.

19. The control method according to claim 11, wherein the electric toothbrush further comprises a bidirectional motor, and the step of controlling the cleaning component to generate the first motion based on the first driving signal and controlling the cleaning component to generate the second motion based on the second driving signal comprises:
controlling the bidirectional motor to drive the cleaning component to generate the first motion based on the first driving signal, and controlling the bidirectional motor to drive the cleaning component to generate the second motion based on the second driving signal.

20. An electric toothbrush, comprising:
a processor; and
a memory;
wherein the memory is configured to store computer programs, and the processor is configured to invoke the computer programs, so that the electric toothbrush executes steps:
obtaining an oral cleaning instruction;
determining a first driving signal and a second driving signal corresponding to the oral cleaning instruction in response to the oral cleaning instruction, controlling a cleaning component to generate a first motion based on the first driving signal, and controlling the cleaning component to generate a second motion based on the second driving signal, wherein a motion direction of the first motion is different from a motion direction of the second motion; and
simultaneously outputting the first driving signal and the second driving signal to enable the cleaning component to performs a combined motion of the first motion and the second motion.
